(19) United States
(12) Patent Application Publication
(10) Pub. No.: US 2016/0367998 A1
(43) Pub. Date: Dec. 22, 2016

(54) SHREDDING MECHANISM, SHREDDER USING THE SAME, AND METHOD OF MANUFACTURING A SHREDDING MECHANISM

(71) Applicant: SAKAE CO., LTD., Tokyo (JP)

(72) Inventors: Yukihiro TAKEDA, kodama-gun (JP); Yoshio MASUKO, kodama-gun (JP); Koichi MATSUMOTO, Fujioka-shi (JP)

(73) Assignee: SAKAE CO., LTD., Tokyo (JP)

(21) Appl. No.: 15/185,955

(22) Filed: Jun. 17, 2016

(30) Foreign Application Priority Data
Jun. 19, 2015 (JP) 2015-123430

(51) Int. Cl. B02C 18/18; B23H 9/12; B23H 9/08; B02C 18/00; B23H 7/02

(52) U.S. Cl. CPC B02C 18/18; B02C 18/0007; B23H 7/02; B23H 9/08; B23H 9/12; B02C 2018/0069

(57) ABSTRACT

A pair of cutter modules arranged so as to mesh with each other each include: a rotary shaft extending along a width direction intersecting with a conveyance direction of an object to be shredded; a plurality of divided cutter blocks arranged along a direction of the rotary shaft and assembled and fixed onto the rotary shaft, each of the cutter blocks including cutter portions with cutting blades, the cutter portions being arranged in a plurality of stages through intermediation of spacer portions; and a positioning mechanism configured to position an assembly of the cutter blocks and the rotary shaft so that the cutting blades of the cutter portions of each cutter block are arranged in an array inclined continuously with the cutting blades of the cutter portions of an adjacent cutter block.

### BACKGROUND OF THE INVENTION

1. Field of the Invention

The present invention relates to a shredding mechanism configured to shred objects to be shredded, such as sheets, and more particularly, to a shredding mechanism including a pair of improved cutter modules arranged so as to mesh with each other, a shredder using the shredding mechanism, and to a method of manufacturing a shredding mechanism.

2. Description of the Related Art

Hitherto, as shredding mechanisms for use in shredders or other devices, there have already been known shredding mechanisms disclosed in, for example, Japanese Patent No. 4855812, Japanese Patent Application Laid-open No. 2007-319774, Japanese Patent Application Laid-open No. 2001-224975, Japanese Utility Model Examined Publication No. Sho 60-28495, and Japanese Patent Application Laid-open No. 2015-003513.

In Japanese Patent No. 4855812 (see Best Mode for carrying out the Invention and FIG. 5), there is disclosed a shredder in which a plurality of substantially disc-like cutters each having a plurality of blades and cut-out recessed portions formed on an outer peripheral surface thereof so as to be repeated alternately in a rotation direction are externally fitted to a pair of rotary shafts in a row so as to be non-rotatable relatively. The pair of rotary shafts are arranged in parallel to each other so that the cutters in one row are caused to enter the spaces between adjacent cutters in the other row alternately with a pitch shift, and the cutters are configured to rotate in opposite directions under a state in which adjacent cutters in both the rows are held in sliding contact with each other. In this shredder, the cutters in each row are mounted to the rotary shaft into alignment so that a line sequentially connecting proximate cutting edges of adjacent cutters forms a helix about the rotary shaft, and a helix angle θ of the helix with respect to an effective shredding width W of the cutters in both the rows for shredding an object to be shredded is set to approximately 180°/n, provided that n is the number of blades of each cutter.

In Japanese Patent Application Laid-open No. 2007-319774 (see Best Mode for carrying out the Invention and FIG. 1), there is disclosed a cutter for a shredder, including a rotary shaft and a plurality of cutter blades arranged on a periphery of the rotary shaft. In this cutter for a shredder, the cutter blades are formed integrally with the rotary shaft by cutting a material together with the rotary shaft. The outer peripheral surface of each of the cutter blades is knurled into a concavo-convex shape by cutting, and the concavo-convex portions formed by knurling are shifted between the cutter blades in a circumferential direction of the rotary shaft.

In Japanese Patent Application Laid-open No. 2001-224975 (see Embodiments of the Invention and FIG. 3), there is disclosed a cutting device including a pair of cutter units each constructed of a plurality of cutter blocks. The pair of cutter units are each formed by alternately mounting disc-like cutter portions and collar portions to a rotary shaft. The cutter portions each include a plurality of blade portions formed on an outer periphery thereof at regular intervals. The collar portions each have a diameter smaller than the diameter of a blade bottom circle formed by the blade portions, and also have a thickness slightly larger than the thickness of the cutter portion. The cutter portions of both the cutter units mesh with each other so as to be positioned alternately, and are mounted so that a blade tip circle formed by the cutter portion on one side and the collar portion on the other side have substantially no gap therebetween. An object to be cut, which is fed between both the cutter units through rotation of the rotary shafts of both the cutter units in opposite directions, is held and cut by the respective blade portions, and is discharged from a portion between both the cutter units.

In Japanese Utility Model Examined Publication No. Sho 60-28495 (see Detailed description of the Device and FIG. 2), there is disclosed a cutter roller for a shredder, in which a plurality of disc-like blades are arranged on an outer surface of a sheath mounted to a rotary shaft in a longitudinal direction of the sheath in a projecting manner at intervals each corresponding to the thickness of the disc-like blade, and a plurality of recessed portions are formed in an outer peripheral surface of the disc-like blade at regular intervals in a circumferential direction, to thereby construct a block cutter. A plurality of the block cutters are mounted to a pair of rotary shafts provided in parallel to each other so that mating block cutters mesh with each other to shred paper into strips.

In Japanese Patent Application Laid-open No. 2015-003513 (see Mode for carrying out the Invention and FIG. 4), there is disclosed a method of manufacturing a cutter wheel made of a hard material that may be subjected to electrical discharge machining and having a cutting edge formed on an outer peripheral surface of the cutter wheel by grinding to have an obtuse cutting edge angle. In this method, in the vicinity of a ridge line of the cutting edge, parts of right and left slopes of the cutting edge are cut away by electrical discharge machining to form recessed portions under a state in which the tip of the obtuse cutting edge is left as it is.

According to, for example, Japanese Patent No. 4855812 and Japanese Patent Application Laid-open No. 2007-319774, as a pair of cutter modules for use in the shredding mechanism for a shredder, there have already been known cutter modules constructed by stacking cutter plates on a rotary shaft one by one, or by forming a rotary shaft and cutter plates integrally with each other. In those types of cutter module, it is understood that the structure in which cutting blades of the cutter portions are arranged in an array inclined at a predetermined angle with respect to the direction of the rotary shaft to disperse cutting loads on the cutter portion has already been employed.

In Japanese Patent Application Laid-open No. 2001-224975, the cutting edge of the blade portion is formed so as to be inclined at a predetermined angle (for example, 20°) with respect to a direction parallel to a rotation axis, and the respective blade portions are formed so as to sequentially have a phase shift corresponding to a predetermined angle (for example, 2.5°). However, this example is mainly intended to cut metal scraps into strips. In the first place, there is no assumption that a highly-accurate cutting portion having a small cutting size is formed. In addition, there is no clear description that the respective blade portions are arranged in an array inclined continuously between the cutter blocks. Therefore, the cutting timings of the blade portions become discontinuous between the cutter blocks, thereby causing a risk in that the cutting resistance fluctuates between the cutter blocks.

In Japanese Utility Model Examined Publication No. Sho 60-28495, the block cutters are formed by cutting, and are easily replaceable even when some of the block cutters are damaged. In the first place, however, there is no assumption that a highly-accurate cutting portion having a small shredding size is formed. In addition, cutting edges of the disc-like blades of the block cutter are not arranged in an array inclined with respect to the direction of the rotary shaft, and are not even arranged so as to be continuous with cutting edges of the disc-like blades of adjacent block cutters. Therefore, the shredding resistance is dispersed on the block cutter basis, thereby causing a risk in that the dispersion of the shredding resistance remains insufficient.

In Japanese Patent Application Laid-open No. 2015-003513, the method of manufacturing a cutter wheel by electrical discharge machining may have already been known, but there is no suggestion of such a manufacturing method that each of the cutter modules for use in the shredding mechanism for a shredder is divided into a plurality of cutter blocks and each of the cutter blocks is subjected to wire electrical discharge machining to form cutter portions and spacer portions.

### SUMMARY OF THE INVENTION

It is a technical object of the present invention to achieve processing of a highly-accurate cutter module having a small shredding size, and to easily achieve maintenance for partial defects.

According to a first technical feature of the present invention, there is provided a shredding mechanism configured to shred an object to be shredded, which is conveyed into the shredding mechanism, the shredding mechanism including a pair of cutter modules arranged so as to mesh with each other, each of the pair of cutter modules including: a rotary shaft extending along a width direction intersecting with a conveyance direction of the object to be shredded; a plurality of divided cutter blocks arranged along a direction of the rotary shaft and assembled and fixed onto the rotary shaft, each of the plurality of divided cutter blocks including cutter portions each having a circular shape in cross-section with cutting blades formed on a periphery of each of the cutter portions at a predetermined pitch, the cutter portions being arranged in a plurality of stages through intermediation of spacer portions each having a circular shape in cross-section and having a predetermined width, the cutter portions and the spacer portions being arranged so that an array of the cutting blades is inclined at a predetermined angle with respect to the direction of the rotary shaft; and a positioning mechanism configured to position an assembly of the plurality of divided cutter blocks and the rotary shaft so that the cutting blades of the cutter portions of the each of the plurality of divided cutter blocks are arranged in an array inclined continuously with the cutting blades of the cutter portions of an adjacent one of the plurality of divided cutter blocks.

According to a second technical feature of the present invention, in the shredding mechanism having the first technical feature, further including a cleaning mechanism configured to clean the pair of cutter modules so as to remove, from the pair of cutter modules, shreds generated through shredding in a meshing region between the pair of cutter modules.

According to a third technical feature of the present invention, in the shredding mechanism having the first technical feature, in the cutter portions of the each of the plurality of divided cutter blocks, which have the cutting blades arranged in an array inclined at the predetermined angle, a circumferential distance between one of the cutting blades positioned so as to face one side surface of the each of the plurality of divided cutter blocks in the direction of the rotary shaft and another one of the cutting blades positioned so as to face another side surface of the each of the plurality of divided cutter blocks in the direction of the rotary shaft is an integral multiple of the predetermined pitch of each of the cutting blades.

According to a forth technical feature of the present invention, in the shredding mechanism having the first technical feature, in the each of the plurality of divided cutter blocks, a thickness of each of the spacer portions is selected so as to become larger than a thickness of the each of the cutter portions.

According to a fifth technical feature of the present invention, in the shredding mechanism having the first technical feature, in the each of the plurality of divided cutter blocks, at least the cutting blades of the cutter portions are formed by wire electrical discharge machining.

According to a sixth technical feature of the present invention, in the shredding mechanism having the first technical feature, the positioning mechanism is provided between the each of the plurality of divided cutter blocks and the rotary shaft or between adjacent cutter blocks among the plurality of divided cutter blocks, and the positioning mechanism includes: a key formed on one of the each of the plurality of divided cutter blocks and the rotary shaft or one of the adjacent cutter blocks among the plurality of divided cutter blocks so as to extend along the direction of the rotary shaft and project in a radial direction of the rotary shaft; and a keyway formed in another one of the each of the plurality of divided cutter blocks and the rotary shaft or another one of the adjacent cutter blocks among the plurality of divided cutter blocks so that the key is slidably fitted to the keyway.

According to a seventh technical feature of the present invention, there is provided, a shredder, including: a shredder casing having a conveyance path for an object to be shredded; the shredding mechanism having the first technical feature or the second technical feature, which is mounted inside the shredder casing and configured to shred the object to be shredded, which is conveyed into the conveyance path; and a trash receiver mounted inside the shredder casing and configured to receive shreds generated through shredding by the shredding mechanism.

According to a eighth technical feature of the present invention, there is provided, a method of manufacturing a shredding mechanism configured to shred an object to be shredded, which is conveyed into the shredding mechanism, the shredding mechanism including a pair of cutter modules arranged so as to mesh with each other, each of the pair of cutter modules including: a rotary shaft extending along a width direction intersecting with a conveyance direction of the object to be shredded; a plurality of divided cutter blocks arranged along a direction of the rotary shaft and assembled and fixed onto the rotary shaft, each of the plurality of divided cutter blocks comprising cutter portions each having a circular shape in cross-section with cutting blades formed on a periphery of each of the cutter portions at a predetermined pitch, the cutter portions being arranged in a plurality of stages through intermediation of spacer portions each having a circular shape in cross-section and having a predetermined width, the cutter portions and the spacer portions being arranged so that an array of the cutting blades is inclined at a predetermined angle with respect to the direction of the rotary shaft; and a positioning mechanism configured to position an assembly of the plurality of divided cutter blocks and the rotary shaft so that the cutting blades of the cutter portions of the each of the plurality of divided cutter blocks become continuous with the cutting blades of the cutter portions of an adjacent one of the plurality of divided cutter blocks, the method including carrying out wire electrical discharge machining for at least processing of the cutting blades of the cutter portions during a manufacturing step for the each of the plurality of divided cutter blocks.

According to a ninth technical feature of the present invention, in the method of manufacturing a shredding mechanism having the eighth technical feature, the manufacturing step for the each of the plurality of divided cutter blocks includes: a spacer portion forming step for forming recessed portions corresponding to the spacer portions by cutting work in regions each positioned between the cutter portions on a peripheral surface of a cylindrical block body; and a cutter portion forming step for processing the cutting blades by the wire electrical discharge machining in regions of the cutter portions each positioned between the recessed portions on the peripheral surface of the cylindrical block body having the recessed portions formed through the spacer portion forming step.

According to a tenth technical feature of the present invention, in the method of manufacturing a shredding mechanism having the ninth technical feature, further including a heat treatment step for quenching the cylindrical block body having the recessed portions formed through the spacer portion forming step, the heat treatment step being carried out in a stage between the spacer portion forming step and the cutter portion forming step.

According to the first technical feature of the present invention, it is possible to achieve the processing of a highly-accurate cutter module having a small shredding size, and to easily achieve the maintenance for partial defects.

According to the second technical feature of the present invention, shreds remaining on the periphery of the cutter module can be removed efficiently, thereby being capable of prolonging the life of the shredding mechanism in comparison with an aspect in which the cleaning mechanism is not used.

According to the third technical feature of the present invention, the layout of the respective cutter blocks on the rotary shaft can be achieved easily in comparison with an aspect in which the configuration of the present invention is not provided.

According to the fourth technical feature of the present invention, the meshing between the cutter modules can be maintained satisfactorily.

According to the fifth technical feature of the present invention, a highly-accurate cutter module having a small shredding size can be processed by wire electrical discharge machining, and the maintenance for partial defects can be achieved easily.

According to the sixth technical feature of the present invention, the positioning of the cutter block with respect to the rotary shaft can be achieved easily.

According to the seventh technical feature of the present invention, it is possible to easily construct the shredder including the shredding mechanism in which a highly-accurate cutter module having a small shredding size can be processed and the maintenance for partial defects can be achieved easily.

According to the eighth technical feature of the present invention, the cutter block that requires fine processing can be manufactured accurately in comparison with the aspect in which the configuration of the present invention is not provided.

According to the ninth technical feature of the present invention, the cutter block that requires the fine processing can be manufactured accurately in a short period of time in comparison with the aspect in which the configuration of the present invention is not provided.

According to the tenth technical feature of the present invention, the cutter block that requires the fine processing can be manufactured accurately in a short period of time while suppressing influence of thermal strain in comparison with the aspect in which the configuration of the present invention is not provided.

### BRIEF DESCRIPTION OF THE DRAWINGS

FIG. 1A is an explanatory view of an overview of a shredder according to an embodiment of the present invention.

FIG. 1B is an explanatory view of a main part of a shredding mechanism to be used in the shredder of FIG. 1A.

FIG. 2 is an explanatory view of an overall configuration of a shredder according to a first embodiment of the present invention.

FIG. 3A is an explanatory view of a main part of the shredder according to the first embodiment of the present invention.

FIG. 3B is an explanatory view of an example of a drive device for a shredding mechanism.

FIG. 4A is a detailed explanatory view of the shredding mechanism to be used in the first embodiment of the present invention.

FIG. 4B is a detailed explanatory view of a meshing region between a pair of cutter modules.

FIG. 5A is a front view of the cutter module to be used in the first embodiment of the present invention.

FIG. 5B is a view in the arrow B direction of FIG. 5A.

FIG. 6A is a perspective view of the cutter module to be used in the first embodiment of the present invention.

FIG. 6B is an explanatory perspective view of a relationship between the cutter module and cutter blocks.

FIG. 7A, FIG. 7B, and FIG. 7C are explanatory views of changes in shape of the cutter block along with a series of manufacturing steps therefor.

FIG. 8A is a perspective view of an intermediate component of the cutter block.

FIG. 8B is a view in the arrow B direction of FIG. 8A.

FIG. 8C is a view in the arrow C direction of FIG. 8A.

FIG. 9A is a perspective view of a finished component of the cutter block.

FIG. 9B is a view in the arrow B direction of FIG. 9A.

FIG. 9C is a view in the arrow C direction of FIG. 9A.

FIG. 10 is an explanatory view of an example of a wire electrical discharge machining apparatus to be used in the manufacturing steps for the cutter block.

FIG. 11A is an explanatory view of an example of end holding structure of the cutter module.

FIG. 11B is an explanatory view of another example of the end holding structure of the cutter module.

FIG. 12A is a perspective view of a main part of a cleaning mechanism to be used in the first embodiment of the present invention.

FIG. 12B is a view in the arrow B direction of FIG. 12A.

FIG. 13A is an explanatory view of a configuration example of a first partition member of the cleaning mechanism.

FIG. 13B is a detailed view of the part B of FIG. 13A.

FIG. 14A is an explanatory view of the configuration example of the first partition member of the cleaning mechanism.

FIG. 14B is an explanatory view of a configuration example of a second partition member of the cleaning mechanism.

FIG. 15A is an explanatory view of an arrangement relationship between the cutter modules of the shredding mechanism and the first partition members of the cleaning mechanism.

FIG. 15B is an explanatory view of an arrangement relationship between the cutter modules of the shredding mechanism and the second partition members of the cleaning mechanism.

FIG. 16A, FIG. 16B, and FIG. 16C are explanatory views of an assembling process of the shredding mechanism.

FIG. 17A is a perspective view of a cutter module to be used in a first modification of the present invention.

FIG. 17B is an explanatory perspective view of a relationship between the cutter module and cutter blocks.

FIG. 18A is a perspective view of a cutter module to be used in a second modification of the present invention.

FIG. 18B is a perspective view of a cutter module to be used in a third modification of the present invention.

FIG. 19A is a perspective view of a main part of a cleaning mechanism to be used in a fourth modification of the present invention.

FIG. 19B is a view in the arrow B direction of FIG. 19A.

FIG. 20 is an explanatory view of an example in which a shredder is applied to an image forming apparatus according to a second embodiment of the present invention.

FIG. 21A is a schematic explanatory view of a cutter block having a lead formed in cutter portions by wire electrical discharge machining.

FIG. 21B is a view in the arrow B direction of FIG. 21A.

FIG. 21C is an explanatory sectional view taken along the line C-C of FIG. 21B.

FIG. 22A, FIG. 22B, and FIG. 22C are explanatory views of performance evaluation of leads to be formed when an axial length of the cutter block is set differently.

### DETAILED DESCRIPTION OF THE PREFERRED EMBODIMENTS

### Overview of Embodiments

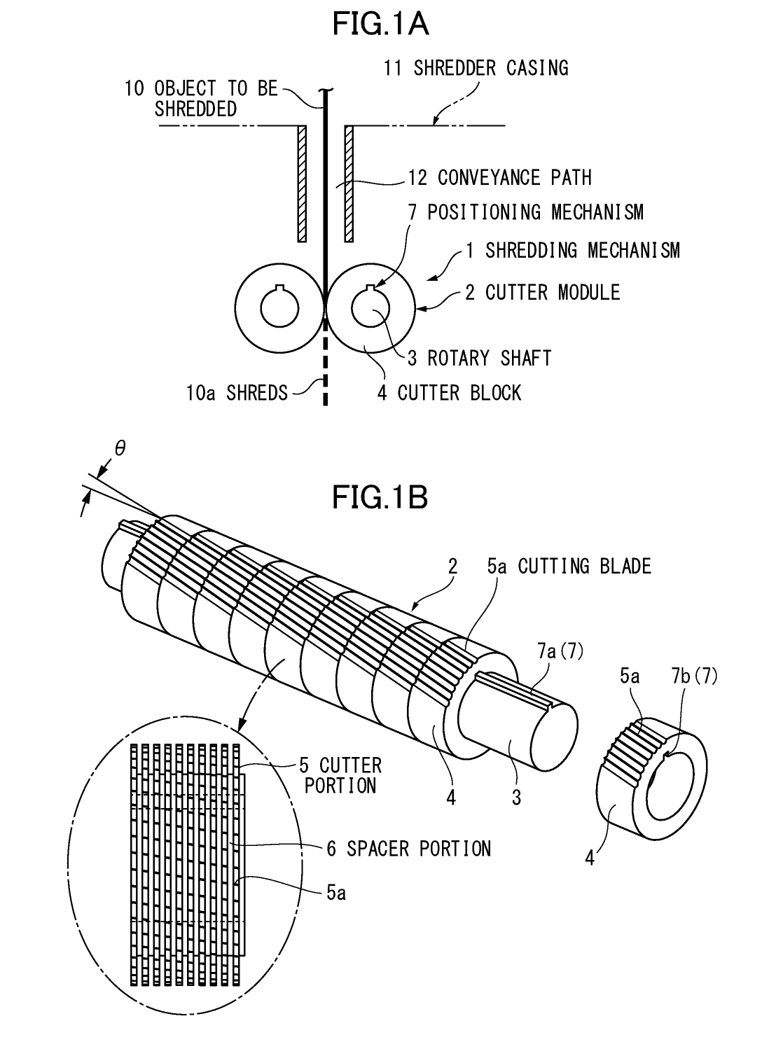

FIG. 1A is an illustration of an overview of a shredder according to an embodiment of the present invention. FIG. 1B is an illustration of a configuration of a cutter module to be used in the shredder.

In FIG. 1A and FIG. 1B, the shredder includes a shredder casing 11 having a conveyance path 12 for an object 10 to be shredded, such as a sheet, a shredding mechanism 1 mounted inside the shredder casing 11 and configured to shred the object 10 to be shredded, which is conveyed into the conveyance path 12, and a trash receiver (not shown) mounted inside the shredder casing 11 and configured to receive shreds generated through the shredding by the shredding mechanism 1.

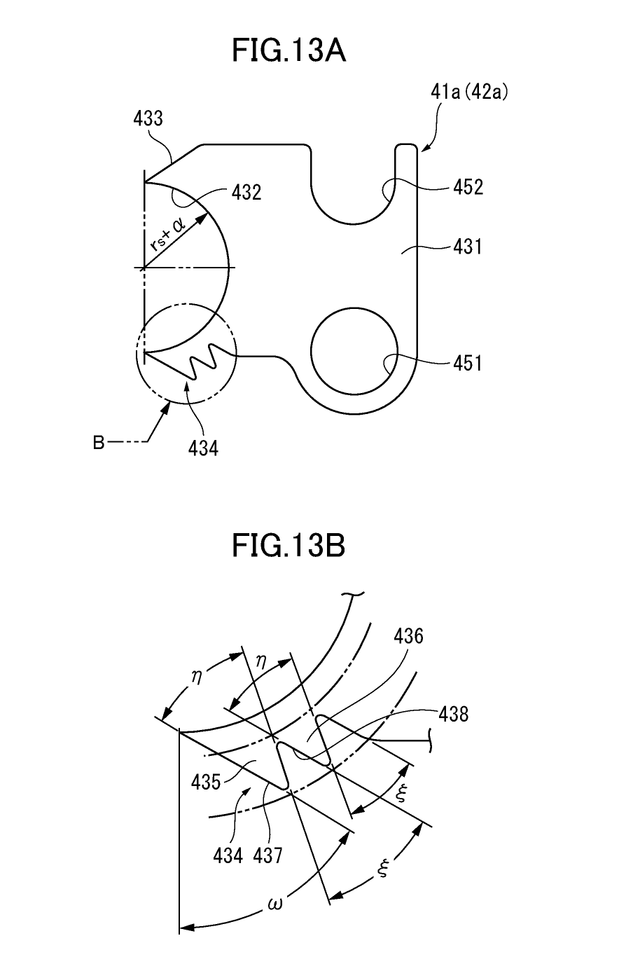

In this embodiment, as illustrated in FIG. 1A and FIG. 13, the shredding mechanism 1 includes a pair of cutter modules 2 arranged so as to mesh with each other. Each cutter module 2 includes a rotary shaft 3 extending along a width direction intersecting with a conveyance direction of the object 10 to be shredded, a plurality of divided cutter blocks 4 arranged along the direction of the rotary shaft, assembled and fixed onto the rotary shaft 3, including cutter portions 5 each having a circular shape in cross-section with cutting blades 5a formed on a periphery thereof at a predetermined pitch and being arranged in a plurality of stages through intermediation of spacer portions 6 each having a circular shape in cross-section and having a predetermined width, and having the cutter portions 5 and the spacer portions 6 arranged so that an array of the cutting blades 5a is inclined at a predetermined angle θ with respect to the direction of the rotary shaft, and a positioning mechanism 7 configured to position an assembly of the cutter blocks 4 and the rotary shaft 3 so that the cutting blades 5a of the cutter portions 5 of each cutter block 4 are arranged in an array inclined continuously with the cutting blades 5a of the cutter portions 5 of adjacent cutter blocks 4.

In such technical measures, the shredding mechanism 1 includes at least the pair of cutter modules 2. Each cutter module 2 includes the rotary shaft 3, the plurality of cutter blocks 4, and the positioning mechanism 7 as the components thereof.

As a first example, the rotary shaft 3 may extend over the entire region of the cutter module 2 in an axial direction thereof. As a second example, the rotary shafts 3 may be provided at both ends of the cutter module 2. In the first example, it is only necessary that the cutter blocks 4 be fitted and fixed to the rotary shaft 3. In the second example, it is only necessary that the cutter blocks 4 be coupled to each other and the cutter blocks 4 positioned at both the ends be coupled to the rotary shafts 3, respectively.

The number of the cutter blocks 4, the shape of the cutting blade 5a of the cutter portion 5, and the thicknesses of the cutter portion 5 and the spacer portion 6 may be selected as appropriate. The length of the cutter block 4 in the direction of the rotary shaft may also be selected as appropriate, but is preferably from about 20 mm to about 40 mm from the viewpoint of suppressing fluctuation in outer diameter of the cutter block 4 in the formation of the cutter portions 5 and the spacer portions 6 by wire electrical discharge machining. The inclination angle θ of the array of the cutting blades 5a of the cutter portions 5 with respect to the direction of the rotary shaft may also be selected as appropriate, but needs to be selected so that the cutting blades 5a of the cutter portions 5 become continuous between the adjacent cutter blocks 4. Further, all the cutter blocks 4 may basically be formed of a common component, but a plurality of types of cutter blocks 4 may be provided separately. For example, the width of a feed port of the shredder casing 11 and the length of the cutter module 2 of the shredding mechanism 1 are selected in conformity with a maximum size of the object 10 to be shredded, such as a sheet (for example, B5, A4, B4, or A3 as specified in the JIS). In this case, preparation of a plurality of types of cutter blocks 4 having different lengths in advance is preferred in terms of versatility when adjusting the length of the cutter module 2.

As the positioning mechanism 7, any mechanism may be employed as long as the assembly of the cutter blocks 4 and the rotary shaft 3 are positioned. A key and a keyway, D-cut surfaces formed in a part of the rotary shaft 3 and a part of the cutter block 4, or other mechanisms are given. In the example in which the rotary shaft 3 extends over the entire region of the cutter module 2 in the axial direction, it is only necessary to employ a configuration for directly positioning each cutter block 4 with respect to the rotary shaft 3. In the example in which the cutter blocks 4 are coupled to each other and the cutter blocks 4 positioned at both ends are coupled to the rotary shafts 3, respectively, it is only necessary that the cutter blocks 4 be positioned at respective coupling portions and each of the cutter blocks 4 positioned at both the ends and the rotary shaft 3 be positioned at a coupling portion therebetween.

Next, description is made of typical examples or preferred examples of the shredder according to embodiments of the present invention.

First, as a typical example of the shredding mechanism 1, there is given a configuration including the pair of cutter modules 2, and a cleaning mechanism (not shown) configured to clean the cutter modules 2 so as to remove, from the cutter modules 2, shreds 10a generated through the shredding in a meshing region between the pair of cutter modules 2.

As the cleaning mechanism of this example, any member (first partition member) having an arbitrary shape may be employed as long as the member at least surrounds the spacer portion 6 of the cutter module 2 and removes the shreds 10a from the periphery of the spacer portion 6 (corresponding to the inside of a recessed portion between the cutter portions 5). Further, as the cleaning mechanism, it is preferred to employ a configuration added with a member (second partition member) that surrounds the cutter portion 5 of the cutter module 2 and closes a gap between the first partition members that the shreds 10a may enter (double-partition system). When reducing the shredding size, the distances between the cutter portions 5 and between the spacer portions 6 become shorter, and hence the thicknesses of the first and second partition members need to be reduced inevitably. Therefore, it is preferred that each partition member be formed into a plate shape to secure surface rigidity.

As a typical example of the cutter block 4, there is given a configuration in which, in the cutter portions 5 having the cutting blades 5a arranged in an array inclined at the predetermined angle θ, a circumferential distance between the cutting blade positioned so as to face one side surface in the direction of the rotary shaft and the cutting blade positioned so as to face the other side surface in the direction of the rotary shaft is an integral multiple of the pitch of the cutting blade. In this example, the cutting blades 5a of the cutter portions 5 of the adjacent cutter blocks 4 are arranged so as to become continuous with each other naturally even when the positioning mechanism 7 for the cutter blocks 4 with respect to the rotary shaft 3 is shared.

As a preferred example of the cutter block 4, there is given a configuration in which the thickness of the spacer portion 6 is selected so as to become larger than the thickness of the cutter portion 5. In this example, the thicknesses of the cutter portion 5 and the spacer portion 6 may be set through arbitrary selection, but the thickness of the spacer portion 6 is preferably larger than the thickness of the cutter portion 5 from the viewpoint of maintaining the meshing between the cutter modules 2 satisfactorily.

As another preferred example of the cutter block 4, there is given a configuration in which at least the cutting blades 5a of the cutter portions 5 are formed by wire electrical discharge machining. Specifically, the cutter block 4 is generally constructed in such a manner that slits are formed in a peripheral surface of a cylindrical block body to divide regions of the cutter portions 5 and the spacer portions 6 from each other and then the cutting blades 5a are processed in the cutter portions 5. At this time, the processing method may be selected as appropriate, but the wire electrical discharge machining is advantageous over cutting work in that fine processing can be achieved, that burrs and deformation are prevented in the processing, and that the material can be processed after quenching (heat treatment). Therefore, the manufacturing method using the wire electrical discharge machining is selected as a preferred manufacturing method particularly for the processing of the cutting blades 5a of the cutter portions 5 that require fine processing.

As a typical example of the positioning mechanism 7, there is given a configuration in which the positioning mechanism 7 is provided between the cutter block 4 and the rotary shaft 3 or between the adjacent cutter blocks 4 and includes a key 7a formed on one of the cutter block 4 and the rotary shaft 3 or one of the adjacent cutter blocks 4 so as to extend along the direction of the rotary shaft and project in a radial direction of the rotary shaft, and a keyway 7b formed in the other one of the cutter block 4 and the rotary shaft 3 or the other one of the adjacent cutter blocks 4 so that the key is slidably fitted to the keyway 7b.

As a typical manufacturing method for the shredding mechanism 1 of this type, there is given a method that involves carrying out wire electrical discharge machining for at least the processing of the cutting blades 5a of the cutter portions 5 during a manufacturing step for the cutter block 4.

In the example in which the plurality of cutter blocks 4 are used for the cutter module 2, the axial length of each cutter block 4 is small, and hence the wire electrical discharge machining can be employed for the processing of the cutting blades 5a of the cutter portions 5, which are arranged in an array inclined with respect to the axial direction.

For example, when the cutter module 2 is an integral cutter module, the axial length is large. Therefore, if the cutting blades 5a are processed in the cutter portions 5 by wire electrical discharge machining, an axial center portion of the cutter module 2 may significantly be recessed in comparison with both ends thereof, and hence the integral cutter module 2 cannot originally be processed by wire electrical discharge machining. In this respect, when the axial length is small as in the case of employing the cutter blocks 4, fluctuation in outer diameter dimension between an axial center portion and each of both ends of the cutter block 4 is suppressed, and hence the wire electrical discharge machining having high processing accuracy can be employed for the processing.

As described above, this example widely encompasses the wire electrical discharge machining carried out during the manufacture of the cutter block 4 for at least the processing of the cutting blades 5a of the cutter portions 5 that require fine processing.

As a preferred example of the manufacturing method for the shredding mechanism 1, there is given a method in which the manufacturing step for the cutter blocks 4 includes: a spacer portion forming step for forming recessed portions corresponding to the spacer portions 6 by cutting work in regions each positioned between the cutter portions 5 on the peripheral surface of the cylindrical block body; and a cutter portion forming step for processing the cutting blades 5a by the wire electrical discharge machining in regions of the cutter portions 5 each positioned between the recessed portions on the peripheral surface of the cylindrical block body having the recessed portions formed through the spacer portion forming step.

This example corresponds to a method of manufacturing the cutter block 4 by “cutting work” and “wire electrical discharge machining” in combination, and is therefore preferred to the method of manufacturing the entire cutter block 4 by “wire electrical discharge machining” in that the period of time required for manufacturing the cutter block 4 can be shortened. The “cutting work” is restricted in tools to achieve fine processing, but is capable of achieving accurate manufacture when, for example, forming the spacer portions 6 on the peripheral surface of the block body. The “wire electrical discharge machining” is capable of achieving highly-accurate fine processing without burrs and deformation that may be caused by cutting during the cutting work, and is therefore carried out for the processing of the cutting blades 5a of the cutter portions 5.

As a preferred example of the manufacturing method for the shredding mechanism 1, there is given a method further including a heat treatment step for quenching the cylindrical block body having the recessed portions formed through the spacer portion forming step, the heat treatment step being carried out in a stage between the spacer portion forming step and the cutter portion forming step. In this example, the “wire electrical discharge machining” is capable of achieving highly-accurate processing also for a high-hardness material obtained by quenching, and hence the quenching step (heat treatment step) is carried out before the cutter portion forming step, thereby being capable of suppressing influence of thermal strain or other phenomena.

Now, description is made of the embodiments of the present invention in more detail with reference to the accompanying drawings.

### First Embodiment

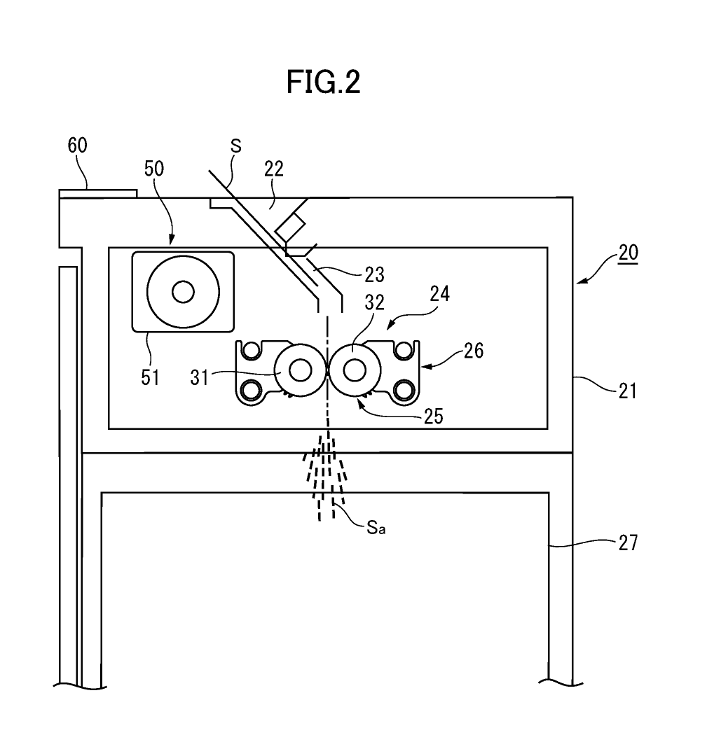

FIG. 2 is an illustration of an overall configuration of a shredder according to a first embodiment of the present invention.

### —Overall Configuration of Shredder—

As illustrated in FIG. 2, a shredder 20 includes a shredder casing 21 having a substantially rectangular parallelepiped shape. A feed port 22 through which a sheet S being an object to be shredded is fed is opened in an upper surface of the shredder casing 21. A conveyance path 23 defined by a pair of guide chutes is provided in the feed port 22. A shredding mechanism 24 is arranged in a midway of the conveyance path 23. Below the shredding mechanism 24 in the shredder casing 21, a trash container 27 configured to receive shreds Sa of the sheet S is arranged so as to be removable.

The shredding mechanism 24 includes a cutter component 25 configured to shred the sheet S, and a cleaning mechanism 26 configured to clean the cutter component 25.

In this example, as illustrated in FIG. 2, the cutter component 25 includes a pair of cutter modules 31 and 32 employing a so-called cross-cut system. When the sheet S is inserted through a meshing region between the pair of cutter modules 31 and 32, the sheet S is shredded simultaneously in a direction along a conveyance direction of the sheet S (longitudinal direction) and in an intersecting direction substantially orthogonal thereto (lateral direction).

In FIG. 2, a drive device 50 is configured to drive the cutter component 25, and an operation panel 60 is configured to operate the shredder 20.

—Drive Device—

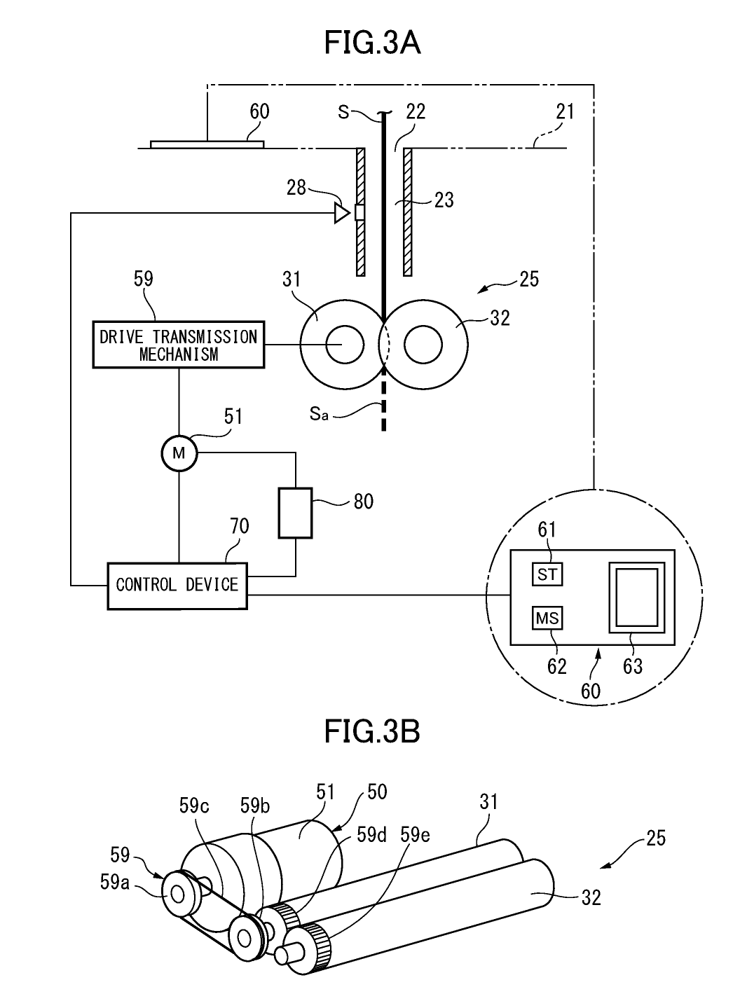

In this embodiment, as illustrated in FIG. 2, FIG. 3A, and FIG. 3B, the drive device 50 includes a drive motor 51 being a drive source, and a drive transmission mechanism 59 configured to transmit a driving force from the drive motor 51 to the pair of cutter modules 31 and 32 of the cutter component 25.

In this example, the drive transmission mechanism 59 includes pulleys 59a and 59b fixed respectively to a drive shaft of the drive motor 51 and a rotary shaft of the first cutter module 31, and a transmission belt 59c looped around the pulleys 59a and 59b. Further, transmission gears 59d and 59e mesh with each other and fixed to the rotary shafts of the pair of cutter modules 31 and 32.

—Control Device—

In this embodiment, as illustrated in FIG. 3A, the drive device 50 configured to drive the cutter component 25 is controlled by a control device 70.

In this example, the control device 70 has a microcomputer system including a CPU, a RAM, a ROM, and input/output ports. The control device 70 receives, for example, operation signals from the operation panel 60, and signals from a position sensor 28 configured to detect whether or not the sheet S is conveyed in the conveyance path 23 via the input/output ports. The control device 70 causes the CPU and the RAM to execute a shredding control program preinstalled in the ROM, to thereby transmit predetermined control signals to the drive device 50 configured to drive the cutter component 25 via the input/output ports.

In addition, a current detector 80 is provided for the drive motor 51 so as to detect drive current supplied to the drive motor 51.

In this example, as illustrated in FIG. 3A, the operation panel 60 includes a start switch 61 (abbreviated as “ST” in FIG. 3A) configured to turn on the shredder 20, a mode selection switch (abbreviated as “MS” in FIG. 3A) configured to perform ON operations to specify, for example, a discharge mode for reversely discharging the sheet S when the sheet S jams in the conveyance path 23, and a cleaning mode for executing cleaning processing when the shreds Sa jam in the cutter component 25, and a display 63 configured to display operating conditions of the shredder 20. Further, as the position sensor 28, sensors of a mechanical type, an optical type, and other types may be selected as appropriate as long as passage of the sheet S can be detected.

—Cutter Component—

In this embodiment, the cutter component 25 includes the pair of cutter modules 31 and 32 as described above.

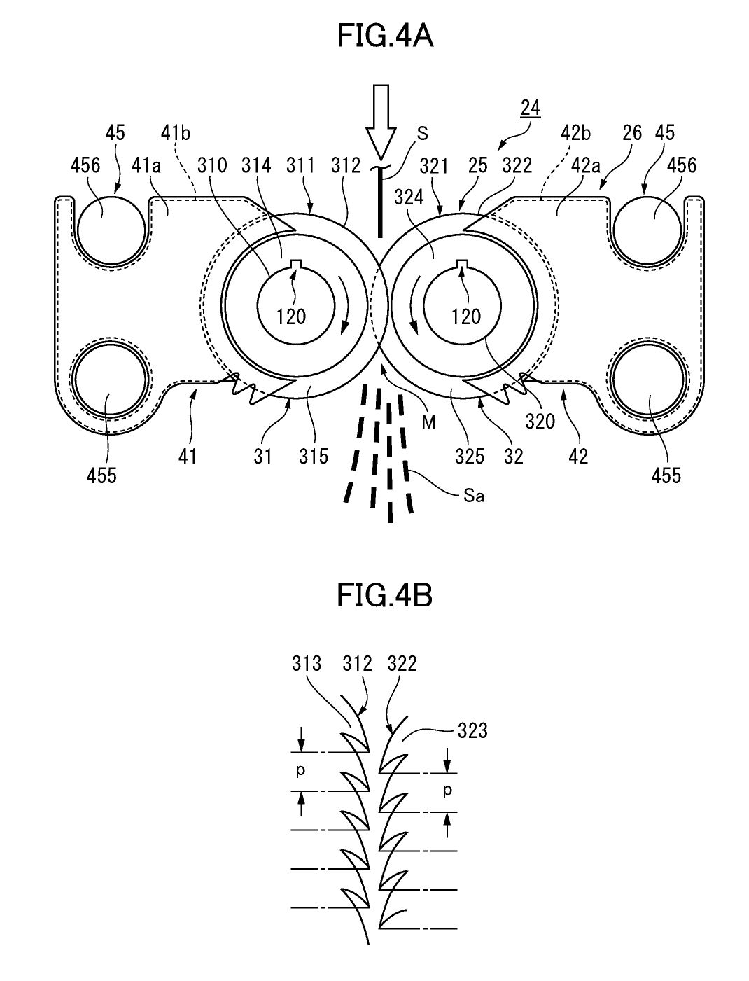

As illustrated in FIG. 3A, FIG. 4A, and FIG. 4B, the first cutter module 31 includes a rotary shaft 310 extending along a width direction intersecting with the conveyance direction of the sheet S, and a cutter assembly 311 fitted and fixed to the rotary shaft 310 and made of a high-strength material such as carbon steel. On a peripheral surface of the cutter assembly 311, cutter portions 312 each having cutting blades 313 formed at a predetermined pitch p (for example, 5 mm) in a rotation direction of the cutter assembly 311 are arrayed through intermediation of spacer portions 314 each having a predetermined width j (for example, 1 mm) along the direction of the rotary shaft. Recessed portions 315 are each formed between the cutter portions 312, and the width dimension of a tip edge of the cutter portion 312 is set approximately equal to that of the recessed portion 315.

In this example, the cutting blades 313 have tip edges as a functional portion configured to cut the sheet S in a direction intersecting with a conveyance direction of the sheet S (lateral direction), and lateral edges, which are positioned on both sides of each of the tip edges, as a functional portion configured to cut the sheet S in a direction along the conveyance direction of the sheet S (longitudinal direction).

As illustrated in FIG. 3A, FIG. 4A, and FIG. 4B, substantially similarly to the first cutter module 31, the second cutter module 32 includes a rotary shaft 320 and a cutter assembly 321, and on a peripheral surface of the cutter assembly 321, cutter portions 322 having cutting blades 323 formed thereon are arrayed through intermediation of spacer portions 324. Recessed portions 325 are each formed between the cutter portions 322.

The second cutter module 32 meshes with the first cutter module 31 so that the cutter portions 322 of the second cutter module 32 bite into the recessed portions 315 of the first cutter module 31, and that the cutter portions 312 of the first cutter module 31 bite into the recessed portions 325 of the second cutter module 32.

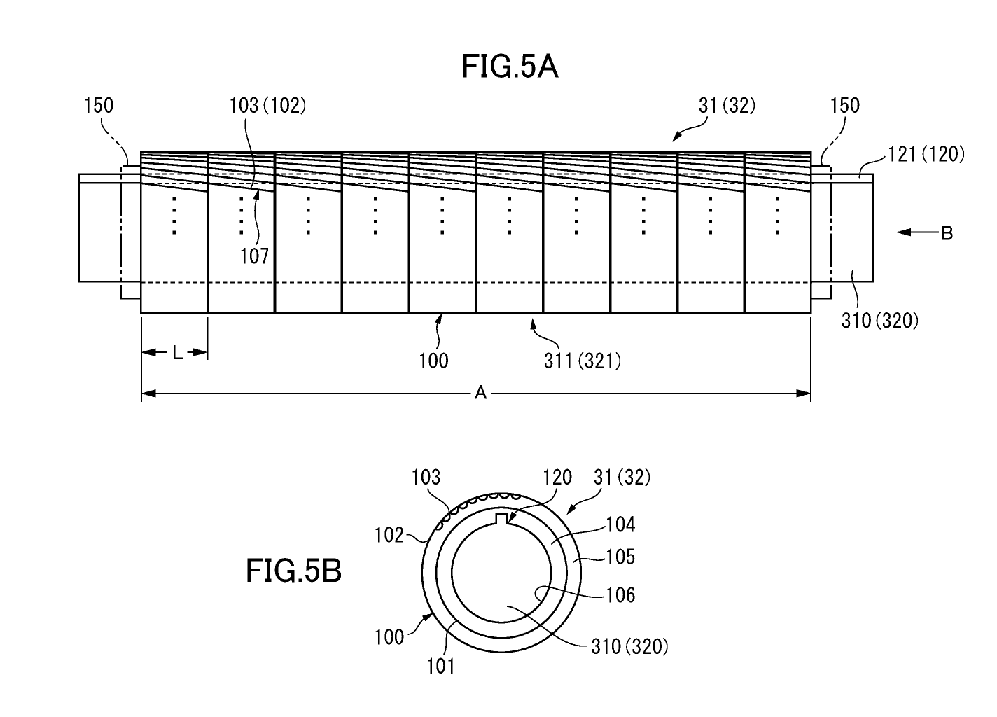

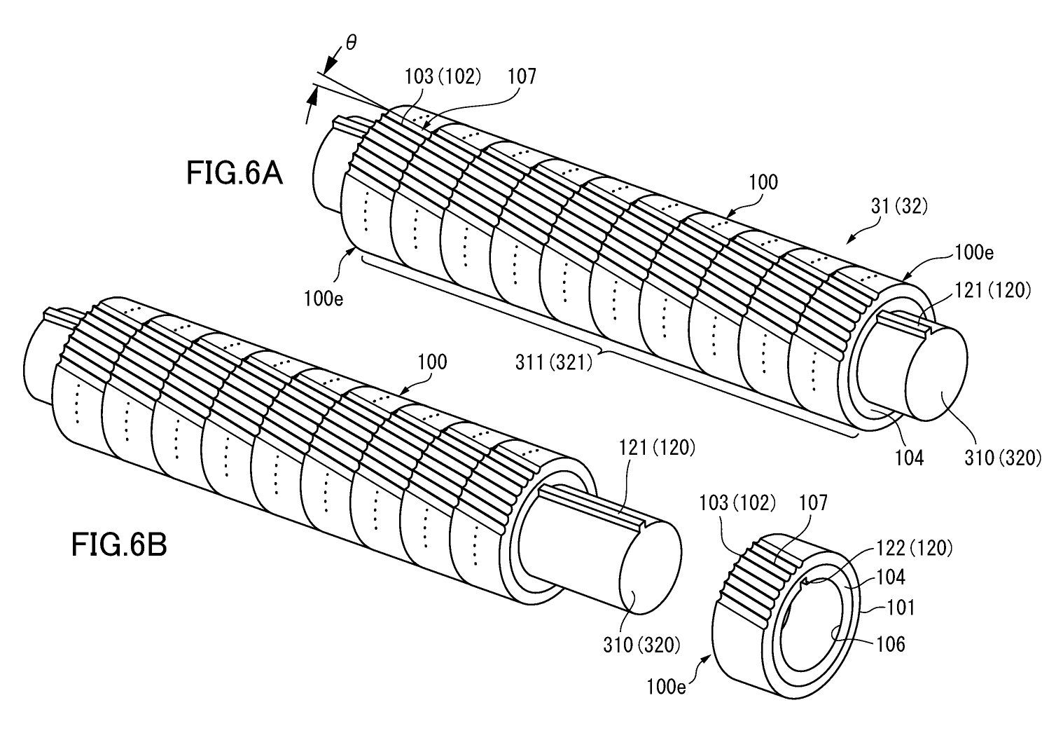

In this embodiment, as illustrated in FIG. 5A and FIG. 6A, the cutter assembly 311 (321) of the cutter module 31 (32) is arranged so that an array of the cutting blades 313 (323) of the cutter portions 312 (322) is inclined at the predetermined angle θ (for example, 10°) with respect to the direction of the rotary shaft, thereby substantially evenly dispersing cutting loads of the cutting blades 313 (323) in the meshing region between the cutter modules 31 and 32.

—Cutter Block—

In this embodiment, as illustrated in FIG. 5A, FIG. 5B, FIG. 6A, and FIG. 6B, the cutter assembly 311 (321) of the cutter module 31 (32) includes a plurality of divided cutter blocks 100 arranged along the direction of the rotary shaft and fitted and fixed to the rotary shaft 310 (320).

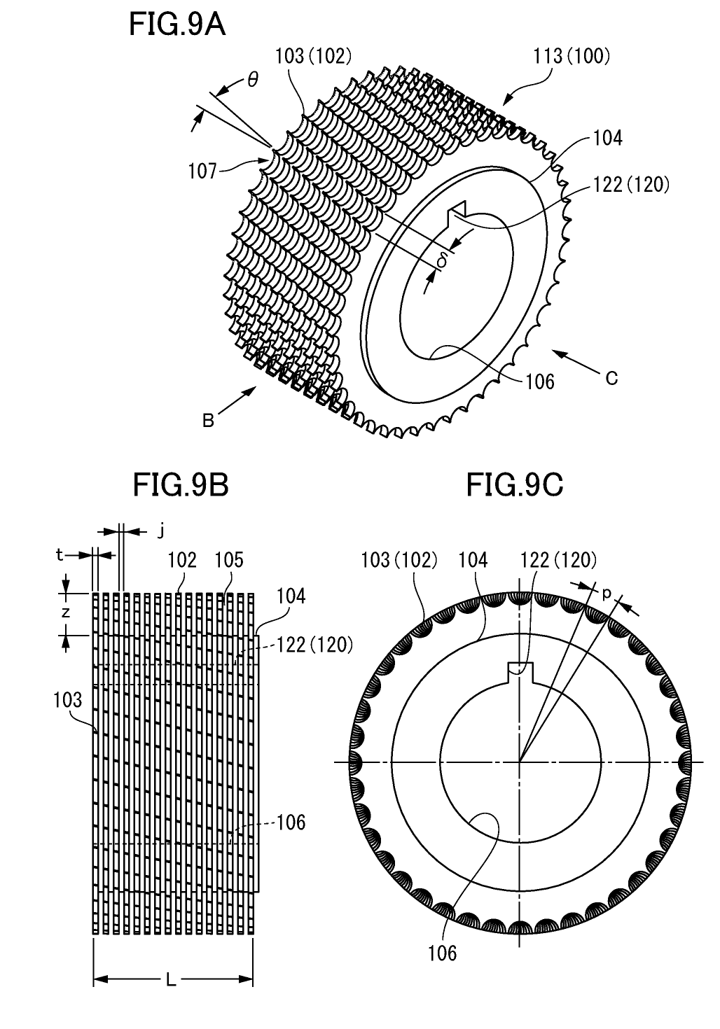

In this embodiment, as illustrated in FIG. 5A, FIG. 5B, FIG. 6A, FIG. 6B, and FIG. 9A to FIG. 9C, the cutter block 100 includes a block body 101 having a predetermined length L (for example, from 20 mm to 40 mm) in the direction of the rotary shaft 310 (320). In the block body 101, an insertion hole 106 is formed so that the rotary shaft 310 (320) is insertable therethrough, and on a periphery of the block body 101, cutter portions 102 each having a circular shape in cross-section with cutting blades 103 formed at the predetermined pitch p (for example, 5 mm) are arranged in a plurality of stages through intermediation of spacer portions 104 each having a circular shape in cross-section and having the predetermined width j (for example, 1 mm) In addition, the cutter portions 102 and the spacer portions 104 are arranged so that an array of the cutting blades 103 is inclined at the predetermined angle θ (for example, 10°) with respect to the direction of the rotary shaft 310 (320). Recessed portions 105 are each formed between the cutter portions 102.

In this example, the above-mentioned angle θ is selected so that, in the cutter portions 102 of the cutter block 100, which have the cutting blades 103 arranged in an array inclined at the predetermined angle θ, a circumferential distance δ between the cutting blade 103 positioned so as to face one side surface in the direction of the rotary shaft and the cutting blade 103 positioned so as to face the other side surface in the direction of the rotary shaft becomes an integral multiple of the pitch p of the cutting blade 103.

For example, when 45 cutting blades 103 are formed in each cutter portion 102, a central angle of the pitch p of the cutting blade 103 is 360°/45=8°. Therefore, the inclination angle θ of the array of the cutting blades 103 of the cutter block 100 with respect to the direction of the rotary shaft only needs to be selected so that the above-mentioned circumferential distance δ corresponds to an angular change of n (integer)×8°.

In this example, the cutter assembly 311 (321) is constructed by fitting the plurality of cutter blocks 100 to the rotary shaft 310 (320), thereby securing a length A equal to or more than a width dimension of the sheet S of the maximum size being an object to be shredded.

Note that, the cutter portion 102, the cutting blade 103, the spacer portion 104, and the recessed portion 105 of the cutter block 100 correspond to the cutter portion 312 (322), the cutting blade 313 (323), the spacer portion 314 (324), and the recessed portion 315 (325) of the cutter assembly 311 (321), respectively.

—Positioning Mechanism—

In this embodiment, a positioning mechanism 120 configured to position each cutter block 100 and the rotary shaft 310 (320) is provided between the cutter block 100 and the rotary shaft 310 (320).

In this example, as illustrated in FIG. 4A, FIG. 4B, FIG. 5A, FIG. 5B, and FIG. 9A to FIG. 9C, the positioning mechanism 120 is provided between each cutter block 100 and the rotary shaft 310 (320), and includes a key 121 having a rectangular shape in cross-section and being formed on the rotary shaft 310 (320) so as to extend along the direction of the rotary shaft and project in a radial direction of the rotary shaft 310 (320), and a keyway 122 having a rectangular shape in cross-section and being formed in a part of a peripheral wall of the insertion hole 106 of the block body 101 so that the key 121 is slidably fitted to the keyway 122. When the key 121 is fitted to the keyway 122, each cutter block 100 is positioned with respect to the rotary shaft 310 (320) under a locked state.

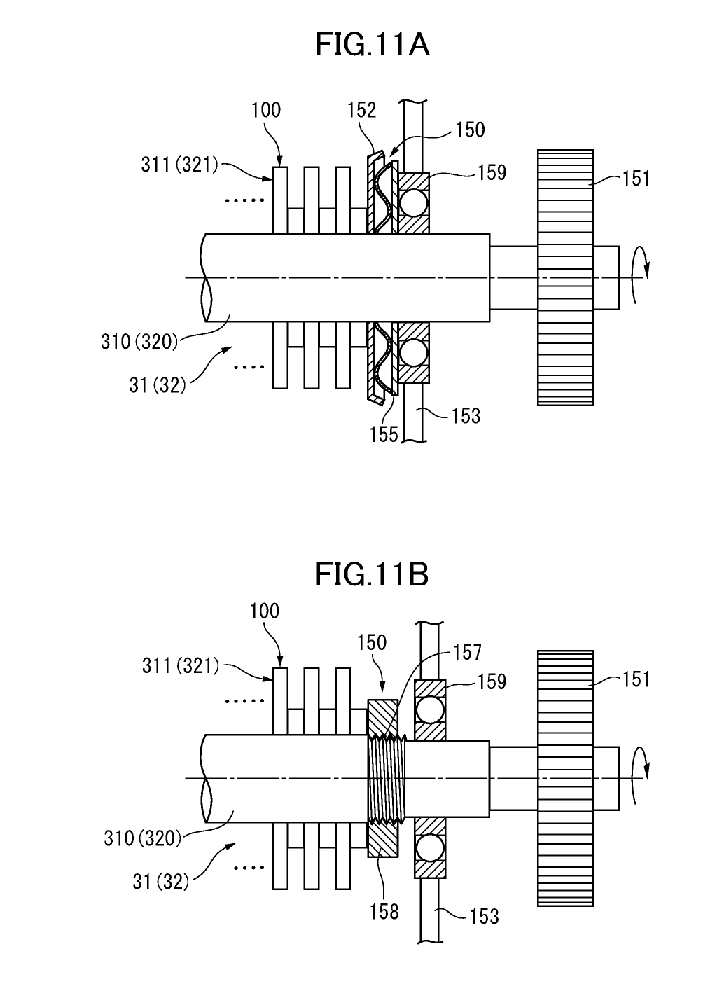

In this example, each cutter block 100 is positioned in the direction of the rotary shaft by an end fastening mechanism 150 described later (see FIG. 11A and FIG. 11B).

In this example, the key 121 is formed on the rotary shaft 310 (320) side and the keyway 122 is formed on the cutter block 100 side, but the present invention is not limited thereto. The positional relationship between the key 121 and the keyway 122 may be reversed.

—Method of Manufacturing Cutter Block—

Next, a method of manufacturing the cutter block 100 is described.

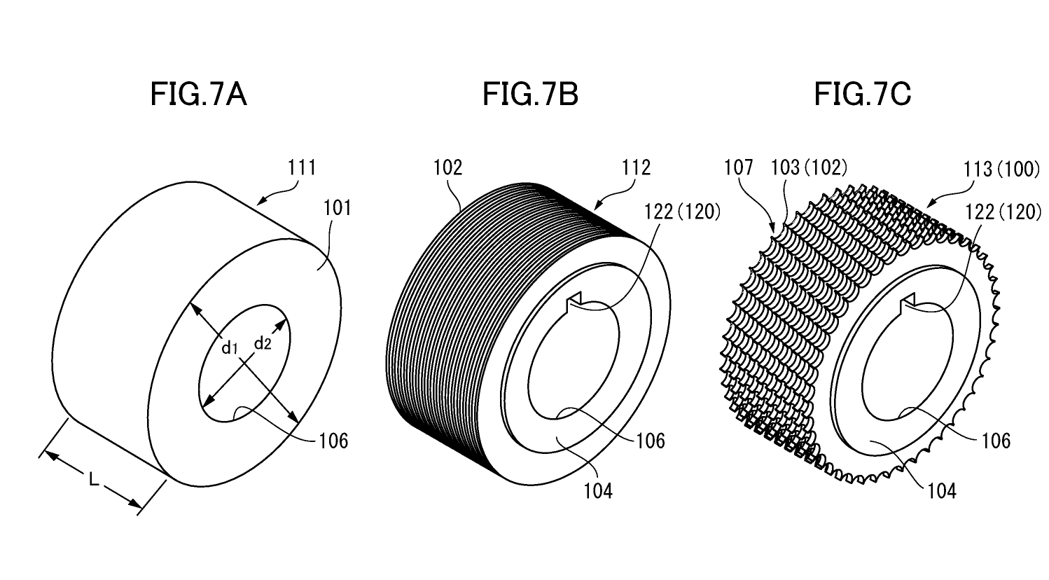

In this example, the method of manufacturing the cutter block 100 involves the following procedure. As illustrated in FIG. 7A, an initial component 111 being a thick cylindrical component having the insertion hole 106 through which the rotary shaft 310 (320) is to be inserted is manufactured of a high-strength material such as carbon steel. Subsequently, as illustrated in FIG. 7B, the keyway 122 is formed in the insertion hole 106 of the initial component 111, and the spacer portions 104 are formed in a peripheral surface of the initial component 111 at portions except for the cutter portions 102, to thereby manufacture an intermediate component 112. After that, as illustrated in FIG. 7C, the cutter portions 102 are formed by processing the cutting blades 103 in a peripheral surface of the intermediate component 112, to thereby manufacture a finished component 113.

### <Initial Component>

When manufacturing the initial component 111, as illustrated in FIG. 7A, an elongate columnar component (corresponding to the block body 101) is first prepared, and the insertion hole 106 (in this example, having an inner diameter d₂) is processed in a center portion of the columnar component (in this example, having an outer diameter d₁), to thereby manufacture an elongate cylindrical component. Subsequently, the cylindrical component is cut to have the predetermined dimension L. Through this procedure, the initial component 111 of the cutter block 100 is obtained.

### <Intermediate Component>

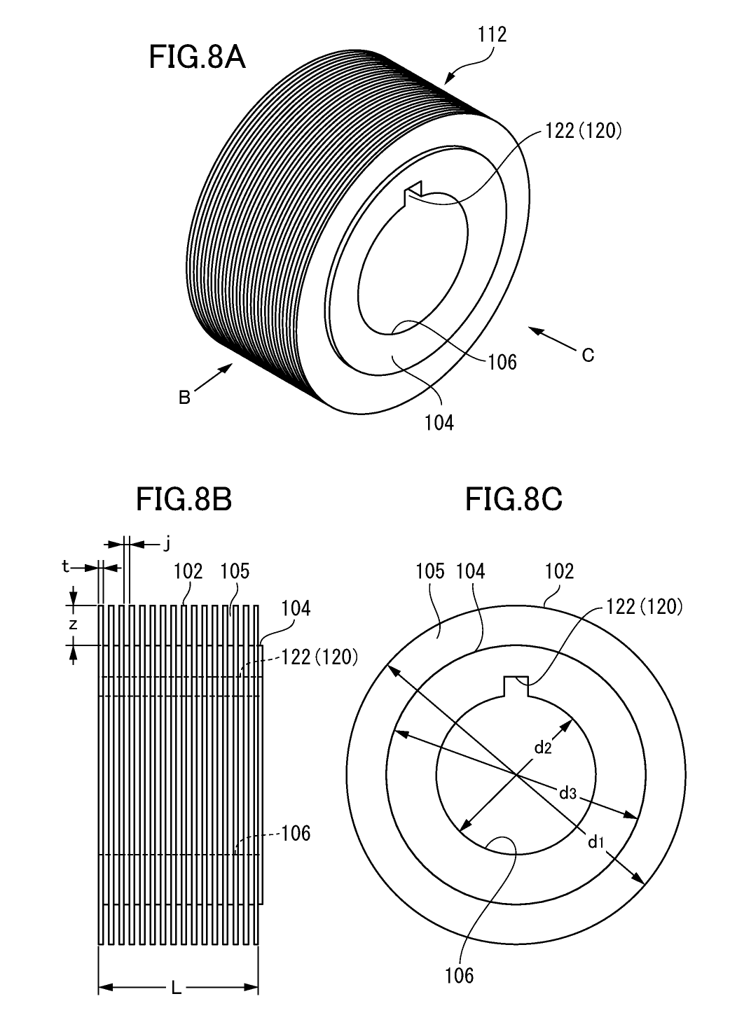

When manufacturing the intermediate component 112, a cutting apparatus such as a lathe is used. As illustrated in FIG. 7B and FIG. 8A to FIG. 8C, the initial component 111 is first fixed to the cutting apparatus, and the keyway 122 is formed in a part of the peripheral wall of the insertion hole 106 of the fixed initial component 111 by cutting work using a cutter. Subsequently, the initial component 111 is supported on the cutting apparatus in a turnable manner, and the recessed portions 105 each having a depth z are formed in the peripheral surface of the initial component 111 at the predetermined width j (for example, 1 mm) by cutting work using a cutter while turning the initial component 111 about a center of the insertion hole 106. Through this procedure, the intermediate component 112 is manufactured so that the regions of the cutter portions 102 and the regions of the spacer portions 104 (in this example, each having an outer diameter d₃) are partitioned from each other.

In this example, when the thickness of the cutter portion 102 is represented by t (for example, 0.9 mm), the dimensions are set so as to satisfy a relationship of t<j from the viewpoint of reducing the loads generated due to the meshing between the cutter portions 102 and the spacer portions 104.

<Finished Component>

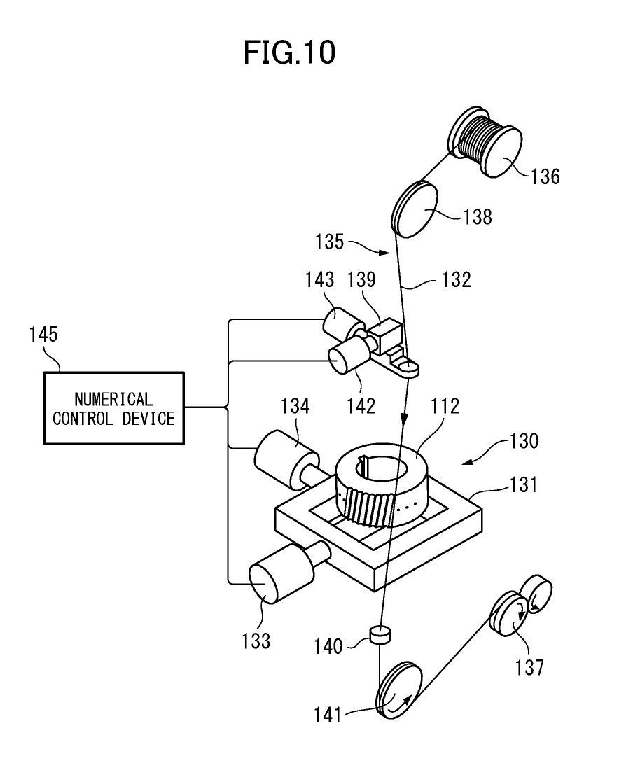

In this embodiment, there is employed a method of manufacturing the finished component 113 through use of a wire electrical discharge machining apparatus 130 illustrated in FIG. 10.

In FIG. 10, the wire electrical discharge machining apparatus 130 includes a movable table 131 on which the intermediate component 112 being a workpiece is placeable. A wire 132 for electrical discharge machining is movably provided in a direction intersecting with the movable table 131. With the wire 132, the intermediate component 112 on the movable table 131 is subjected to electrical discharge machining.

In this example, the movable table 131 is movable on an XY plane by an X-axis drive unit 133 and a Y-axis drive unit 134.

The wire 132 is movable by a wire moving mechanism 135. For example, the wire moving mechanism 135 is configured to collect the wire 132, which is unreeled from a wire feeding portion 136 arranged on an upper side, at a wire collecting portion 137 arranged on a lower side. Specifically, the wire moving mechanism 135 is configured to guide the wire 132 from the wire feeding portion 136 along a predetermined locus through an upper pulley 138, an upper wire guide 139, a lower wire guide 140, and a lower pulley 141. In this example, the upper wire guide 139 is, for example, movable on a UV plane by a U-axis drive unit 142 and a V-axis drive unit 143, whereas the lower wire guide 140 is arranged under a fixed state.

In this example, all of the X-axis drive unit 133, the Y-axis drive unit 134, the U-axis drive unit 142, and the V-axis drive unit 143 are connected to a numerical control device 145. The numerical control device 145 is configured to control the respective drive units based on numerical data input in advance to shift the position of the intermediate component 112 being a workpiece and the position of the wire 132 so that the intermediate component 112 is subjected to wire electrical discharge machining.

In this example, when manufacturing the finished component 113, the wire electrical discharge machining apparatus 130 is used. As illustrated in FIG. 7C and FIG. 9A to FIG. 9C, the wire 132 is moved along a direction inclined at the angle θ with respect to the direction of the rotary shaft so that the regions of the cutter portions 102 each positioned between the spacer portions 104 on the peripheral surface of the intermediate component 112 are subjected to electrical discharge machining with the wire 132 to form the cutting blades 103 at the predetermined pitch p. Through this procedure, the finished component 113 is manufactured.

The following are advantages and precautions when the wire electrical discharge machining is employed to manufacture the finished component 113.

(1) The wire electrical discharge machining involves electrical melting with a metal wire, and is therefore an optimum method for fine processing of, for example, the cutting blades 103 of the cutter portions 102 each having a small shredding size.

In this respect, for example, when the cutting apparatus is used for carrying out processing to achieve a small shredding size, the thicknesses of the rotary cutter of the cutting apparatus and the cutting blades themselves to be formed by cutting work are reduced. Therefore, a precaution needs to be taken in that the rotary cutter and the cutting blades are liable to be damaged. Further, burrs may be generated at the portions subjected to cutting work or the portions may be clogged with chips. Therefore, a precaution of carrying out cleaning needs to be taken after the cutting work.

(2) When the cutting blades 103 of the cutter portions 102 each having a small shredding size are processed by wire electrical discharge machining, as illustrated in FIG. 9B, a larger height dimension z than in the case of cutting work can be secured for each cutting blade 103 so that the number of objects that are shreddable at a time can be increased correspondingly.

That is, when the cutting apparatus is used for processing the cutting blades 103 of the cutter portions 102 each having a small shredding size, the thicknesses of the rotary cutter of the cutting apparatus and the cutting blades 103 of the cutter portions 102 are reduced as described above, and hence both of the rotary cutter and the cutting blades 103 are liable to be damaged. Therefore, it is difficult to secure a large height dimension z for each cutting blade 103 of the cutter portion 102. In contrast, the wire electrical discharge machining has no such risk.

(3) In this example, the wire electrical discharge machining is carried out to manufacture the finished component 113. The “wire electrical discharge machining” is capable of achieving highly-accurate processing also for a high-hardness material obtained by quenching, and hence the quenching step (heat treatment step) is carried out for the manufactured intermediate component 112 before the cutter portion forming step, thereby being capable of suppressing influence of thermal strain or other phenomena.
(4) In this example, the cutting blades 103 of the cutter block 100 are formed by wire electrical discharge machining in such a manner that an array of the cutting blades 103 is inclined at the predetermined angle θ with respect to the direction of the rotary shaft. Therefore, when the length L of the cutter block 100 becomes larger, the outer diameter of the cutter portion 102 at a center portion of a lead (helix) 107 formed of the array of the cutting blades 103 arranged with inclination tends to become smaller than the outer diameter of the cutter portion 102 at each of both ends of the lead 107. Thus, it is only necessary to select the length L of the cutter block 100 within a range in which fluctuation in outer diameter of the cutter portion 102 on the lead 107 of the cutter block 100 does not cause a problem with the shredding performance of the cutter module 31 (32).

Details of this point are described in an example described later.

—Assembling of Cutter Module—

In this embodiment, steps of assembling the cutter module 31 (32) are carried out as follows.

First, as illustrated in FIG. 6A and FIG. 6B, a predetermined number of the cutter blocks 100 are sequentially fitted to the rotary shaft 310 (320), and then the cutter blocks 100 positioned at both ends of the rotary shaft 310 (320) (in this example, cutter blocks 100e) are positioned and fixed by the end fastening mechanism 150.

As the end fastening mechanism 150, for example, as illustrated in FIG. 11A, a holding washer 152 is fitted to each of both the ends of the rotary shaft 310 (320) to which drive is to be transmitted from a drive gear 151. At least at one end of the rotary shaft 310 (320), a wave washer 155 is interposed between a support frame 153 of the cutter module 31 (32) and the holding washer 152, and the respective cutter blocks 100 are pressed and held with an urging force of the wave washer 155, to thereby regulate the positions of the respective cutter blocks 100 in the direction of the rotary shaft.

As another example, as illustrated in FIG. 11B, in place of the wave washer 155, a male screw portion 157 is formed at the end of the rotary shaft 310 (320), and a fastening nut 158 threadedly engaged with the male screw portion 157 is tightened so that the respective cutter blocks 100 are pressed and held, to thereby regulate the positions of the respective cutter blocks 100 in the direction of the rotary shaft. As a matter of course, the holding washer 152 and the wave washer 155 may be interposed between the fastening nut 158 and the cutter block 100e positioned at the end.

In FIG. 11A and FIG. 11B, a bearing 159 is configured to rotatably support the rotary shaft 310 (320).

As described above, when the respective cutter blocks 100 are fitted to the rotary shaft 310 (320), the respective cutter blocks 100 are positioned with respect to the rotary shaft 310 (320) under a locked state through the engagement between the key 121 and the keyway 122 of the positioning mechanism 120, and are also positioned in the direction of the rotary shaft 310 (320) through the fastening carried out by the end fastening mechanism 150.

In this state, the respective cutter blocks 100 are integrated as the cutter assembly 311 (321) and assembled as the cutter module 31 (32).

In this example, as illustrated in FIG. 9A, the inclination angle θ of the lead 107 of each cutter block 100 is selected so that the circumferential distance δ between the cutting blade 103 positioned so as to face one side surface in the direction of the rotary shaft and the cutting blade 103 positioned so as to face the other side surface in the direction of the rotary shaft becomes an integral multiple of the pitch p of the cutting blade 103. Therefore, as illustrated in FIG. 6A, the respective cutter blocks 100 of the cutter assembly 311 (321) are arranged so that the respective leads 107 become continuous with each other at the inclination angle θ with respect to the rotary shaft 310 (320).

—Cleaning Mechanism—

### <Basic Configuration of Scraper>

In this embodiment, as illustrated in FIG. 4A, the cleaning mechanism 26 includes scrapers 41 and 42 serving as scraping members provided in regions different from a meshing region M between the pair of cutter modules 31 and 32 and configured to scrape off the shreds Sa adhering to peripheries of the cutter modules 31 and 32. As each of the scrapers 41 and 42, a plate member made of a high-strength material such as carbon steel is used.

In this example, the scraper 41 includes first partition members 41a provided so as to surround substantially left half of the first cutter module 31, which is positioned on an opposite side of the meshing region M between the pair of cutter modules 31 and 32, and provided correspondingly to the spacer portions 314 positioned between the cutter portions 312 of the first cutter module 31, and second partition members 41b arranged between the first partition members 41a correspondingly to the cutter portions 312 of the first cutter module 31.

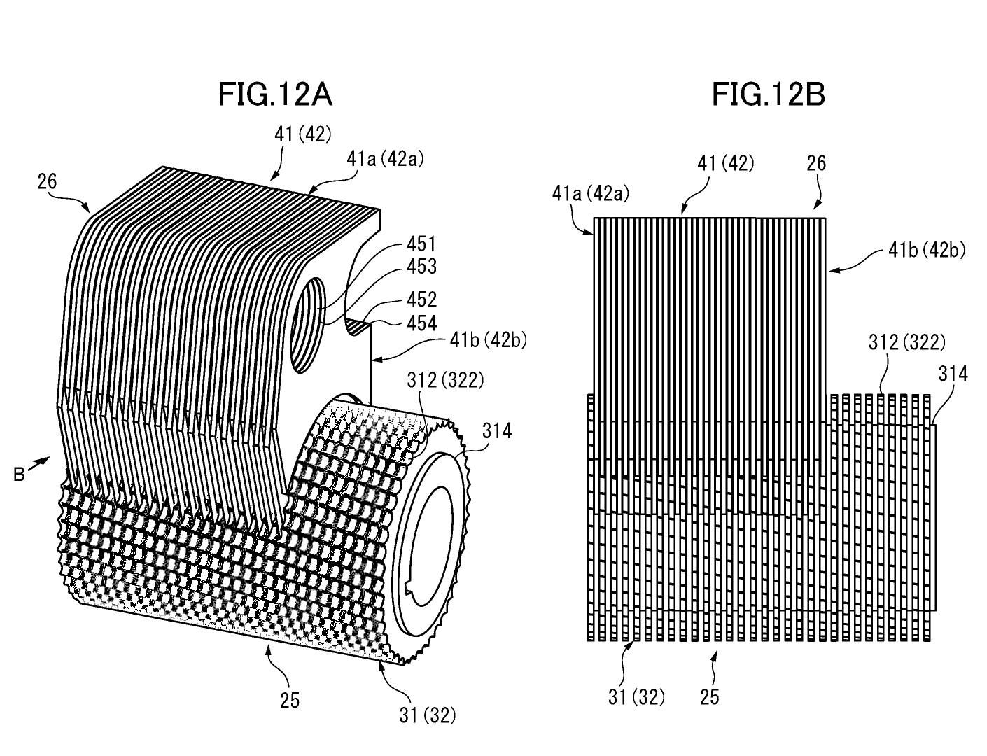

As illustrated in FIG. 4A, FIG. 12A, and FIG. 12B, the first partition members 41a are arranged so as to bite into the spacer portions 314 positioned between the cutter portions 312 of the first cutter module 31. With this, among the shreds Sa generated through the shredding in the meshing region M between the pair of cutter modules 31 and 32, the shreds Sa accumulated in the recessed portions 315 on the peripheries of the spacer portions 314 are scraped off.

As illustrated in FIG. 4A, FIG. 12A, and FIG. 12B, the second partition members 41b are arranged so as to surround the cutter portions 312 of the first cutter module 31. With this, among the shreds Sa generated through the shredding in the meshing region M between the pair of cutter modules 31 and 32, the shreds Sa adhering to peripheries of the cutter portions 312 are scraped off.

On the other hand, the scraper 42 includes first partition members 42a provided so as to surround substantially right half of the second cutter module 32, which is positioned on an opposite side of the meshing region M between the pair of cutter modules 31 and 32, and provided correspondingly to the spacer portions 324 positioned between the cutter portions 322 of the second cutter module 32, and second partition members 42b arranged between the first partition members 42a correspondingly to the cutter portions 322 of the second cutter module 32.

As illustrated in FIG. 4A, FIG. 12A, and FIG. 12B, the first partition members 42a are arranged so as to bite into the spacer portions 324 positioned between the cutter portions 322 of the second cutter module 32. With this, among the shreds Sa generated through the shredding in the meshing region M between the pair of cutter modules 31 and 32, the shreds Sa accumulated in the recessed portions 325 on the peripheries of the spacer portions 324 are scraped off.

As illustrated in FIG. 4A, FIG. 12A, and FIG. 12B, the second partition members 42b are arranged so as to surround the cutter portions 322 of the second cutter module 32. With this, among the shreds Sa generated through the shredding in the meshing region M between the pair of cutter modules 31 and 32, the shreds Sa adhering to peripheries of the cutter portions 322 are scraped off.

<Configuration Example of First Partition Members>

As illustrated in FIG. 4A, FIG. 12A, FIG. 12B, FIG. 13A, and FIG. 13B, the first partition members 41a (42a) each include a plate-like partition body 431, and have a circular-arc edge surface (in this example, semicircular edge surface) 432 being a bottom of the recessed portion 315 (325) of the cutter module 31 (32) at a part of the partition body 431, which follows the spacer portion 314 (324). Further, a guide surface 433 configured to guide the sheet S into the meshing region M between the pair of cutter modules 31 and 32 is formed on a side of the partition body 431, on which the sheet S is conveyed. In addition, a guide piece 434 configured to guide downward the shreds Sa generated through the shredding in the meshing region M between the pair of cutter modules 31 and 32 is formed on a side of the partition body 431, on which the sheet S is discharged.

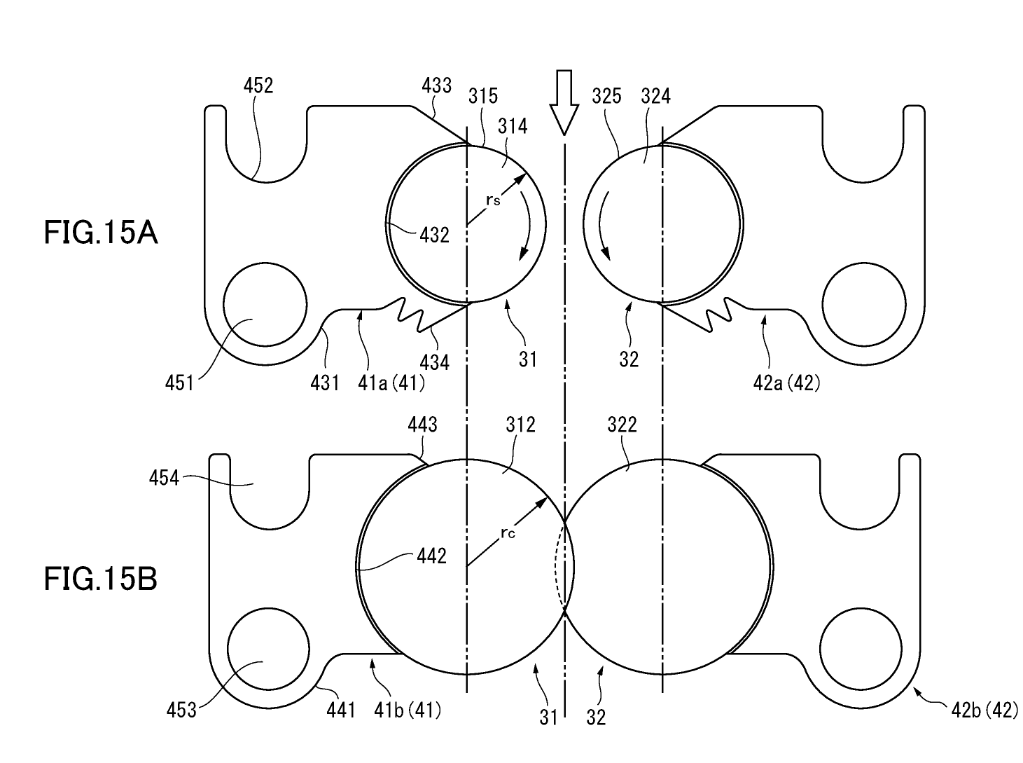

In this example, as illustrated in FIG. 13A and FIG. 15A, the edge surface 432 of the first partition member 41a (42a) is formed into a circular-arc surface having a radius of rs+α, which is slightly larger than a radius rs of the spacer portion 314 (324) positioned between the cutter portions 312 (322) of the cutter module 31 (32).

In this example, as illustrated in FIG. 13A and FIG. 13B, the guide piece 434 includes two mountain-shaped guide projections 435 and 436 extending obliquely downward. The guide projection 435 positioned closer to a path of the sheet S has, for example, an inclined surface 437 inclined at a predetermined angle ω (for example, from 30° to 50°) with respect to a vertical direction, and has a tip corner portion projecting at an angle η (for example, from 20° to 40°:η<ω in this example). Further, the another guide projection 436 is formed, for example, to be adjacent to the guide projection 435 through intermediation of a V-groove 438 having a tip angle ξ (for example, from 20° to 40°, ξ=η in this example), and to project at a tip angle η.

<Configuration Example of Second Partition Members>

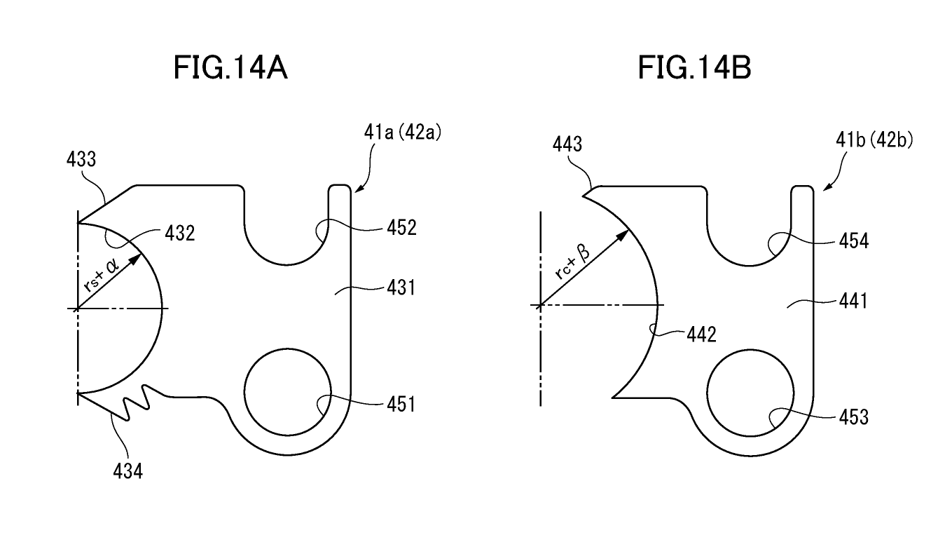

As illustrated in FIG. 4A, FIG. 12A, FIG. 12B, FIG. 14A, and FIG. 14B, the second partition members 41b (42b) each include a plate-like partition body 441, and have a circular-arc edge surface (in this example, an angle of the circular arc is less than that of a semicircular, an edge surface of from 140° to 150°, for example) 442 conforming to tip outer rims of the cutter portions 312 (322) of the cutter module 31 (32) at a part of the partition body 441.

In this example, as illustrated in FIG. 143 and FIG. 15B, the edge surface 442 of the second partition member 41b (42b) is formed into a circular-arc surface having a radius of rc+β, which is slightly larger than a radius rc of the tip outer rims of the cutter portions 312 (322) of the cutter module 31 (32).

In this example, the second partition members 41b (42b) are each formed so as to have a guide surface 443 following the guide surfaces 433 of the first partition members 41a (42a) when the second partition members 41b (42b) are overlapped with the first partition members 41a (42a), and to have an upper side, a lower side, and a lateral side that is positioned on an opposite side of the edge surface 432, which substantially match with those of the partition body 431 of the first partition members 41a (42a).

<Positioning Mechanism>

In this embodiment, as illustrated in FIG. 4A and FIG. 12A to FIG. 153, the cleaning mechanism 26 includes a positioning mechanism 45 capable of positioning the first partition members 41a (42a) and the second partition members 41b (42b) of the scraper 41 (42).

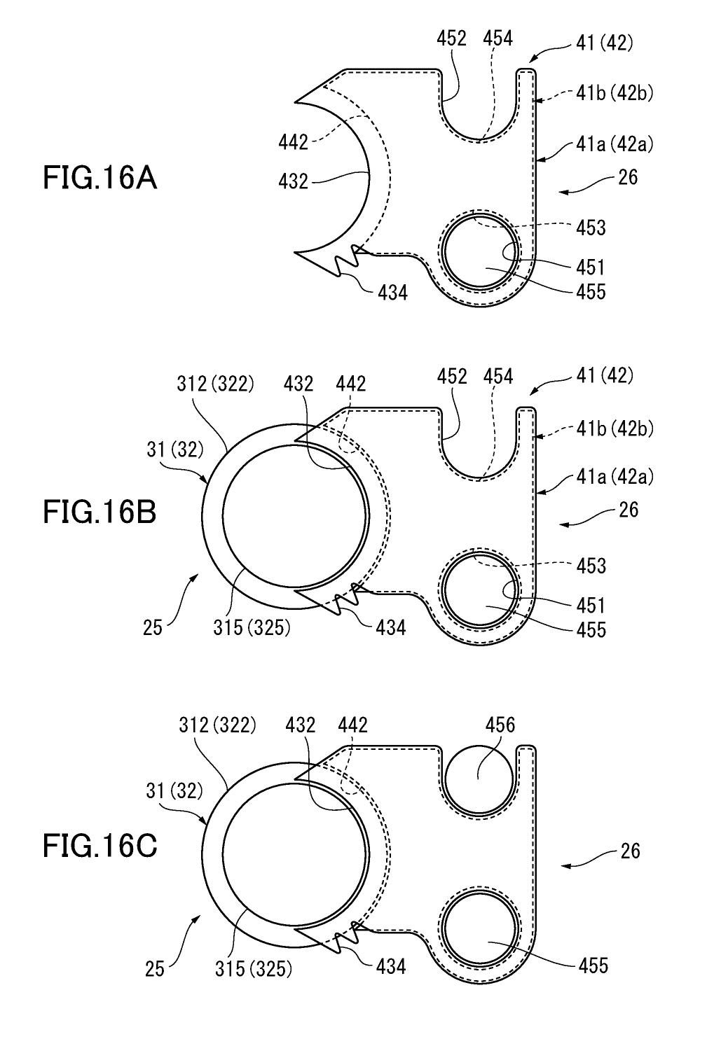

In this example, in the positioning mechanism 45, a circular positioning hole 451 is opened at an arbitrary position (in this example, a lower corner portion on a side away from the cutter module 31 (32)) in the partition body 431 of each of the first partition members 41a (42a). A U-shaped positioning groove 452 is formed at a part away from the positioning hole 451 (in this example, the upper side of the partition body 431, which is positioned right above the positioning hole 451). In addition, in the partition body 441 of each of the second partition members 41b (42b), a positioning hole 453 and a positioning groove 454 are formed as counterparts at positions corresponding to the positioning hole 451 and the positioning groove 452 of the first partition members 41a (42a). Under a state in which the first partition members 41a (42a) and the second partition members 41b (42b) are stacked alternately to each other, a first positioning rod 455 (see FIG. 16A to FIG. 16C) is inserted through the positioning holes 451 and 453, and a second positioning rod 456 is inserted through the positioning grooves 452 and 454. With this, the first partition members 41a (42a) and the second partition members 41b (42b) of the scraper 41 (42) are positioned.

—Assembling Process of Shredding Mechanism—

Description is made of an assembling process of the shredding mechanism 24 in this embodiment.

In order to assemble the shredding mechanism 24, the cleaning mechanism 26 needs to be assembled to the pair of cutter modules 31 and 32 serving as the cutter component 25.

First, as illustrated in FIG. 16A, as the scraper 41 (42) serving as the cleaning mechanism 26, the first partition members 41a (42a) and the second partition members 41b (42b) are stacked alternately to each other, and then the first positioning rod 455 is inserted through the positioning holes 451 and 453.

In this state, the first partition members 41a (42a) and the second partition members 41b (42b) are freely pivotable about a position of the first positioning rod 455.

Then, as illustrated in FIG. 16B, around the cutter module 31 (32) serving as the cutter component 25, the first partition members 41a (42a) and the second partition members 41b (42b) of the scraper 41 (42) are arranged respectively at parts corresponding to the recessed portions 315 (325) of the cutter module 31 (32) and parts corresponding to the cutter portions 312 (322) of the cutter module 31 (32).

Next, at a stage when the arrangement of the partition members 41a and 41b (42a and 42b) of the scraper 41 (42) serving as the cleaning mechanism 26 is completed, the second positioning rod 456 is inserted through the positioning grooves 452 and 454 of the first partition members 41a (42a) and the second partition members 41b (42b).

In this state, as illustrated in FIG. 16C, when the positioning rods 455 and 456 are positioned to predetermined positions in the shredder casing 21, the scrapers 41 and 42 are positioned with respect to the cutter modules 31 and 32 with reference to the positions of the positioning rods 455 and 456. In this way, the shredding mechanism 24 is mounted at a predetermined position in the shredder casing 21.

—Shredding Control Processing of Shredder—

Next, description is made of shredding control processing of the shredder according to this embodiment mainly with reference to FIG. 3A, FIG. 3B, and FIG. 4A.

### <Normal Shredding Processing>

First, when the control device 70 determines that the ON operation has been input via the start switch 61 of the operation panel 60, the control device 70 specifies a predetermined one of driving conditions of the drive device 50 (such as a driving speed condition of the drive motor 51).

In this state, the sheet S, which is fed into the feed port 22 of the shredder casing 21, is moved to the shredding mechanism 24 along the conveyance path 23. At this time, when the position sensor 28 detects the passage of the sheet S, the signal detected by the position sensor 28 is transmitted to the control device 70. In response thereto, the drive motor 51 drives the pair of cutter modules 31 and 32 serving as the cutter component 25 in accordance with the predetermined one of the driving conditions.

In this example, the sheet S is shredded simultaneously in the longitudinal and lateral directions by passing through the meshing region M between the pair of cutter modules 31 and 32. The shreds Sa generated through the shredding are scraped off from the cutter modules 31 and 32 by the scrapers 41 and 42 serving as the cleaning mechanism 26, and fall downward.

In such shredding processing, the shreds Sa are generated through the shredding into an extremely small size of, for example, 0.7 mm×3.5 mm (2.45 mm²). Thus, even when attempts are made to reproduce information of the original sheet by collecting the shreds Sa after the shredding processing, the reproduction is nearly impossible because the shredding size of the shreds Sa is small.

Then, when a predetermined time period elapses after a trailing edge of the sheet S passes by the position sensor 28 (time period in which completion of the shredding processing is presumed), the control device 70 determines that the shredding processing has been completed, and stops driving of the drive motor 51. With this, a series of the shredding control processing is completed.

In particular, in this embodiment, the cutter assemblies 311 and 321 each constructed of the plurality of cutter blocks 100 are employed for the cutter modules 31 and 32, respectively. As illustrated in FIG. 6A, the respective cutter blocks 100 constructing each of the cutter assemblies 311 and 321 are arranged so that the respective leads 107 become continuous with each other at the inclination angle θ with respect to each of the rotary shafts 310 and 320. Therefore, the shredding loads in the meshing region M between the cutter modules 31 and 32 are dispersed substantially evenly in the direction of each of the rotary shafts 310 and 320, and are maintained without fluctuating significantly at the coupling portion between the cutter blocks 100, thereby eliminating a risk of such behavior that the shredding performance of each of the cutter modules 31 and 32 at the coupling portion between the cutter blocks 100 is different from the shredding performance at other portions or degraded abruptly.

—Cleaning Processing by Cleaning Mechanism—

In such normal shredding processing, many of the shreds Sa generated through the shredding in the meshing region M between the pair of cutter modules 31 and 32 fall downward to be received in the trash container 27.

However, apart of the shreds Sa may electrostatically adhere to the peripheries of the cutter modules 31 and 32.

As a countermeasure, as illustrated in FIG. 4A, FIG. 12A, and FIG. 12B, the scraper 41 (42) serving as the cleaning mechanism 26 of this embodiment includes not only the first partition members 41a (42a) but also the second partition members 41b (42b). Thus, not only the shreds Sa in the recessed portions 315 (325) positioned on the peripheries of the spacer portions 314 (324) of the cutter modules 31 and 32, but also the shreds Sa adhering to the cutter portions 312 (322) are scraped off.

Thus, a risk in that the shreds Sa are accumulated while electrostatically adhering to the peripheries of the cutter modules 31 and 32 is significantly low.

In particular, in this embodiment, the first partition members 41a and the second partition members 41b (42a and 42b) respectively form, over a wide range, the edge surfaces 432 and 442 that are close respectively to the bottom surfaces of the recessed portions 315 (325) positioned on the peripheries of the spacer portions 314 (324) of the cutter module 31 (32) and the tip outer rims of the cutter portions 312 (322). Thus, the shreds Sa electrostatically adhering to the peripheral surfaces of the cutter modules 31 and 32 do not pass through minute gaps between the partition members 41a and 42a (41b and 42b).

Further, in this embodiment, the first partition members 41a (42a) each include the guide piece 434 as illustrated in FIG. 13A and FIG. 13B. Thus, the shreds Sa electrostatically adhering to the peripheral surfaces of the cutter modules 31 and 32 strike against the guide piece 434, and then are guided downward. In particular, the guide piece 434 of this example includes the two guide projections 435 and 436, and the V-groove 438 is formed between the guide projections 435 and 436. Thus, even when the shreds Sa electrostatically adhere near the guide piece 434, the shreds Sa fall near the V-groove 438. In this way, a risk in that the shreds Sa remain as they are near the guide piece 434 is significantly low.

First Modification

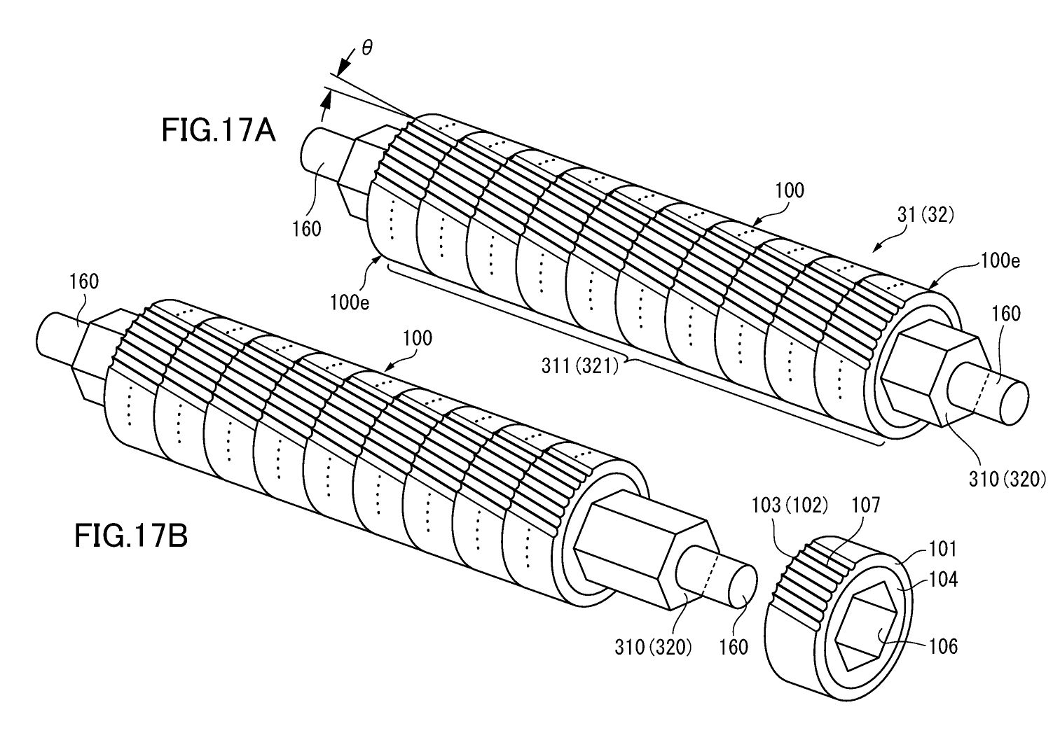

In this embodiment, the cutter module 31 (32) is constructed such that, for example, the respective cutter blocks 100 are fitted to the cylindrical rotary shaft 310 (320) and positioned with respect to the rotary shaft 310 (320) by the positioning mechanism 120 (key 121 and keyway 122), but the present invention is not limited thereto. For example, as illustrated in FIG. 17A and FIG. 17B, a rotary shaft 310 (320) having a regular n-sided polygonal shape in cross-section (in this example, n=6) and cutter blocks 100 in which the number of the cutting blades 103 of each cutter portion 102 is an integral multiple of n are prepared, and an insertion hole 106 having a regular n-sided polygonal shape in cross-section is formed in the block body 101 of each cutter block 100 so that the rotary shaft 310 (320) is insertable therethrough. The respective cutter blocks 100 are sequentially inserted onto the rotary shaft 310 (320), and both ends of the cutter assembly 311 (321) constructed of the plurality of cutter blocks 100 are positioned with respect to the rotary shaft 310 (320) by the end fastening mechanism (not shown).

In this example, the inner peripheral surface of the insertion hole 106 of the cutter block 100, which has a regular n-sided polygonal shape in cross-section, and the outer peripheral surface of the rotary shaft 310 (320), which has a regular n-sided polygonal shape in cross-section, serve also as the positioning mechanism 120 configured to lock the cutter block 100.

In particular, in this example, the insertion hole 106 of the cutter block 100 is formed into a regular n-sided polygonal shape, and the number of the cutting blades 103 is divisible by n. Therefore, even when the insertion positions of the respective cutter blocks 100 on the rotary shaft 310 (320) vary in the circumferential direction, the leads 107 formed of the array of the cutting blades 103 of the respective cutter blocks 100 are arranged so as to become continuous with each other at the predetermined inclination angle θ with respect to the direction of the rotary shaft.

In this example, support portions 160 each having a circular shape in cross-section and being supportable by the bearings (not shown) are provided at both ends of the rotary shaft 310 (320) having a regular n-sided polygonal shape.

In this example, the positioning mechanism 120 formed of, for example, the key and the keyway may be provided separately. In this case, the respective cutter blocks 100 are inserted onto the rotary shaft 310 (320) while keeping predetermined circumferential positions, respectively. Thus, the number of the cutting blades 103 of each cutter portion 102 of the cutter block 100 can be selected irrespective of the number n of sides of the regular polygonal shape of the rotary shaft 310 (320).

A D-cut surface may be formed as the shape of the rotary shaft 310 (320) in cross-section by cutting a part of the circular shape in cross-section, and a D-cut surface may also be formed in the insertion hole 106 of each cutter block 100 so that the rotary shaft 310 (320) is insertable therethrough. Thus, the respective cutter blocks 100 are inserted onto the rotary shaft 310 (320) while keeping predetermined circumferential positions, respectively.

Second Modification

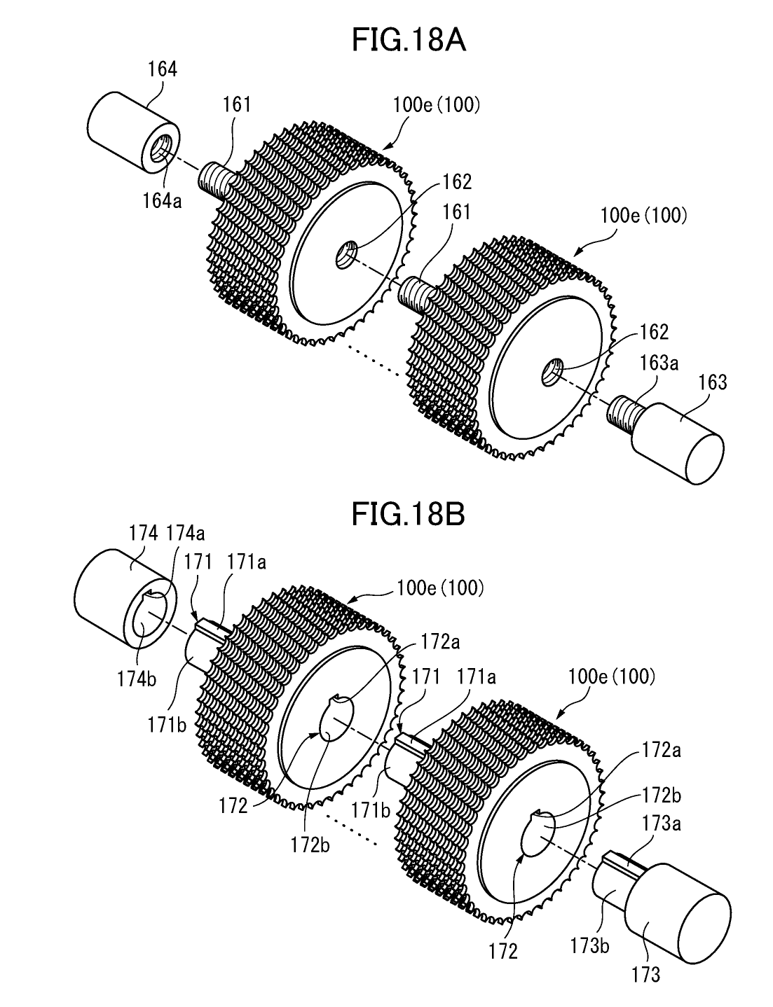

In this embodiment or in the first modification, all of the cutter blocks 100 are inserted onto the rotary shaft 310 (320) and locked on the rotary shaft 310 (320) by the positioning mechanism 120, but the present invention is not limited thereto. For example, the following configuration may be given as illustrated in FIG. 18A. A male screw portion is formed as a coupling portion 161 at a center of one side surface of each cutter block 100, and a female screw portion is formed as a mating coupling portion 162 at a center of the other side surface of each cutter block 100. The respective cutter blocks 100 are coupled to each other through intermediation of the coupling portions 161 and the mating coupling portions 162, and rotary shafts 163 and 164 are coupled to the respective ends of the cutter blocks 100e positioned at the ends. In this example, the rotary shaft 163 on one side has a male screw portion 163a to be threadedly engaged with the mating coupling portion 162 of the cutter block 100e at the end, whereas the rotary shaft 164 on the other side has a female screw portion 164a to be threadedly engaged with the coupling portion 161 of the cutter block 100e at the end.

As described above, in this example, the positioning mechanism 120 functions separately as the coupling mechanism configured to position and couple the cutter blocks 100 (coupling portion 161 and mating coupling portion 162), and as the coupling mechanism configured to position and couple the cutter blocks 100e at the ends and the rotary shafts 163 and 164 (coupling portion 161, mating coupling portion 162, male screw portion 163a, and female screw portion 164a).

Third Modification

As a third modification, for example, the following configuration may be given as illustrated in FIG. 183. A coupling boss 171b with a key 171a formed at a part of a peripheral surface thereof is formed as a coupling portion 171 at the center of one side surface of each cutter block 100, and a coupling hole 172b with a keyway 172a formed so that the coupling portion 171 is fittable thereto is formed as a mating coupling portion 172 at the center of the other side surface of each cutter block 100. The respective cutter blocks 100 are coupled to each other through intermediation of the coupling portions 171 and the mating coupling portions 172, and rotary shafts 173 and 174 are coupled to the respective ends of the cutter blocks 100e positioned at the ends. In this example, the rotary shaft 173 on one side has a coupling boss 173b with a key 173a to be fitted to the mating coupling portion 172 of the cutter block 100e at the end, whereas the rotary shaft 174 on the other side has a coupling hole 174b with a keyway 174a to be fitted to the coupling portion 171 of the cutter block 100e at the end.

As described above, in this example, the positioning mechanism 120 functions separately as the coupling mechanism configured to position and couple the cutter blocks 100 (coupling portion 171 and mating coupling portion 172), and as the coupling mechanism configured to position and couple the cutter blocks 100e at the ends and the rotary shafts 173 and 174 (coupling portion 171, mating coupling portion 172, coupling boss 173b with key 173a, and coupling hole 174b with keyway 174a).

Fourth Modification

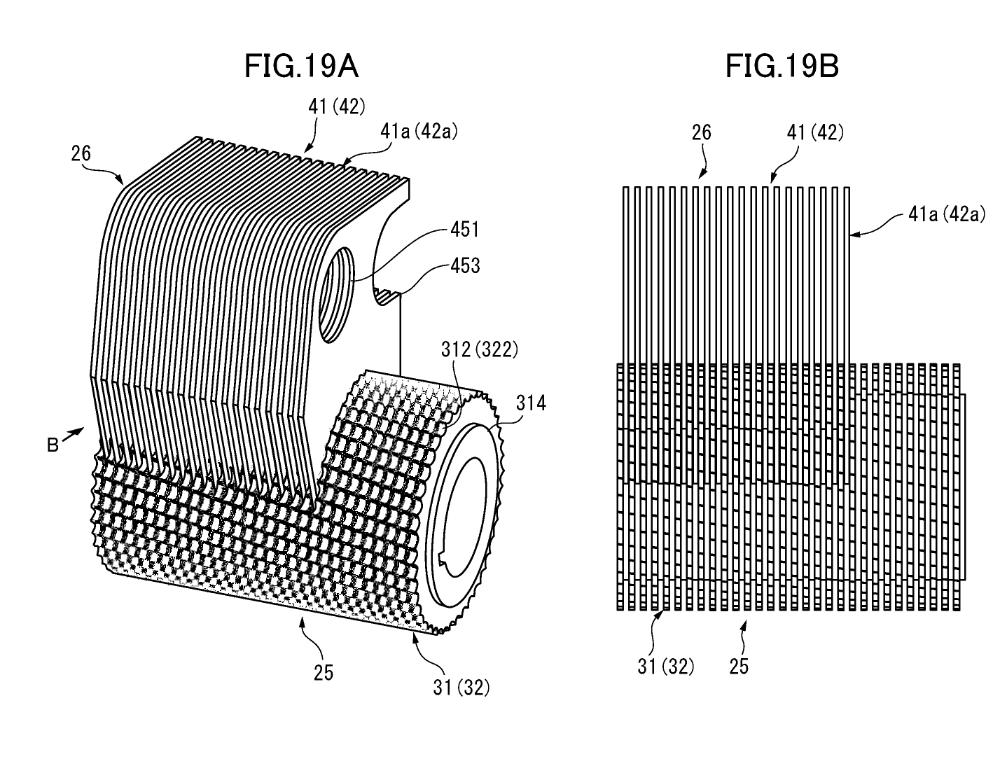

In this embodiment, the scraper 41 (42) serving as the cleaning mechanism 26 includes the first partition members 41a (42a) and the second partition members 41b (42b), but the present invention is not necessarily limited thereto. Depending on a required cleaning function, for example, as illustrated in FIG. 19A and FIG. 19B, the first partition members 41a (42a) may be used alone without using the second partition members 41b (42b).

Fifth Modification

In this embodiment, in each cutter block 100, the intermediate component 112 is manufactured through the step of cutting work, whereas the finished component 113 is manufactured through the step of wire electrical discharge machining, but the present invention is not limited to the combination of those steps. For example, both of the intermediate component 112 and the finished component 113 may be manufactured through the step of wire electrical discharge machining, or other manufacturing methods may be selected as appropriate.

### Second Embodiment

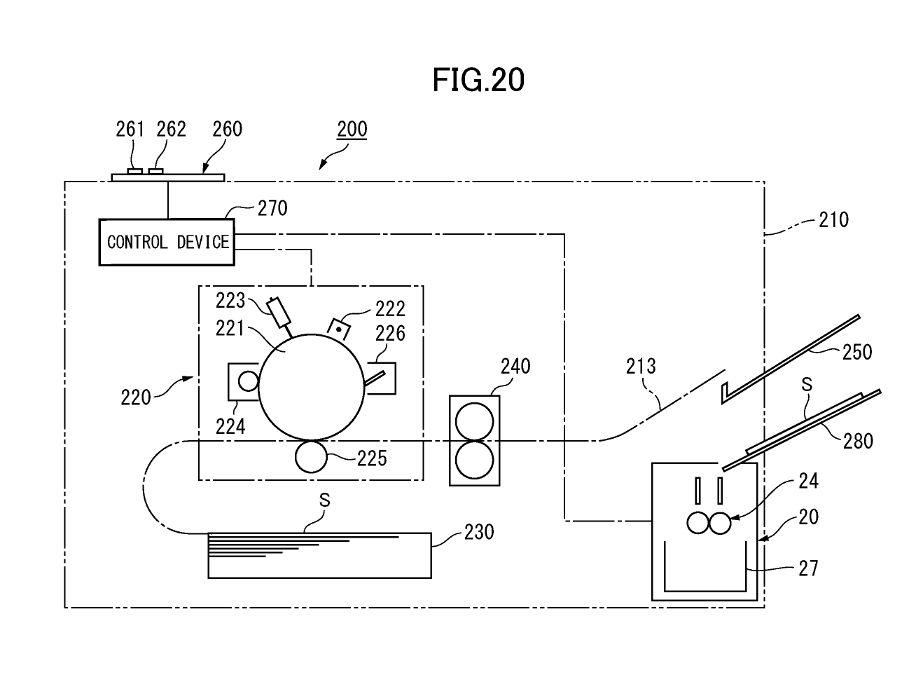

FIG. 20 is an explanatory view of a main part of an image forming apparatus according to a second embodiment of the present invention.

In FIG. 20, an image forming apparatus 200 has an apparatus casing 210 in which the shredder 20 is mounted.

In this example, the image forming apparatus 200 has a basic configuration in which the apparatus casing 210 includes an image forming unit 220 capable of forming an electrophotographic image. The sheet S fed from a sheet feeding tray 230 is conveyed along a predetermined conveyance path 213 up to the image forming unit 220, and an image formed in the image forming unit 220 is transferred onto the sheet S. Then, the image is fixed onto the sheet S by, for example, a fixing device 240 of a heating-and-pressing type. A sheet receiving tray 250 is configured to receive the sheet S having an image formed thereon by normal image forming processing in the image forming unit 220.

As an example of the image forming unit 220, there is given an image forming unit 220 including, around a photosensitive member 221, a charging device 222 configured to charge the photosensitive member 221, an exposure device 223 configured to form the electrostatic latent image on the charged photosensitive member 221, a developing device 224 configured to develop the electrostatic latent image formed on the photosensitive member 221 into a visible image with toner, a transfer device 225 configured to electrostatically transfer the image (toner image), which is formed on the photosensitive member 221, onto the sheet S, and a cleaning device 226 configured to remove residual matter on the photosensitive member 221 after the transfer.

In this embodiment, the shredder 20 is mounted in the apparatus casing 210, and a sheet guide tray 280 configured to guide the sheet S into the shredder 20 is provided, for example, on a lateral side of the apparatus casing 210. With this, the sheet S to be shredded is guided from the sheet guide tray 280 into the shredder 20.

Any of the shredders 20 used as in the first and second embodiments and in the modifications may be applied as the shredder 20 used in this embodiment.

In addition, the apparatus casing 210 includes an operation panel 260 of the image forming apparatus 200. The operation panel 260 includes not only an image forming operation portion 261 configured to execute the normal image forming processing, but also a shredding operation portion 262 for the shredder 20 (corresponding to, for example, the operation panel 60 in the first embodiment). A control device 270 configured to control the image forming apparatus 200 in response to operations to the operation panel 260 is further provided.

Next, description is made of an operation of the image forming apparatus according to this embodiment.

In FIG. 20, when the image forming operation portion 261 of the operation panel 260 is operated, the control device 270 transmits, in accordance with an image forming mode, control signals necessary for image formation to the image forming unit 220, the sheet feeding tray 230, the fixing device 240, and the conveyance system for the sheet S so as to execute a series of image forming processing.

On the other hand, under a state in which the sheet S to be shredded is set to the sheet guide tray 280, when the shredding operation portion 262 of the operation panel 260 is operated so that the sheet S is fed into the shredder 20, the normal shredding processing on the sheet S is executed in accordance with demand from a user.

In this example, the shredder 20 is mounted in the image forming apparatus 200. Thus, there is an advantage in that, even when the image forming processing by the image forming unit 220 fails to be properly executed on some of the sheets S, the shredding processing can be immediately executed by the shredder 20.

### EXAMPLE

### Example 1

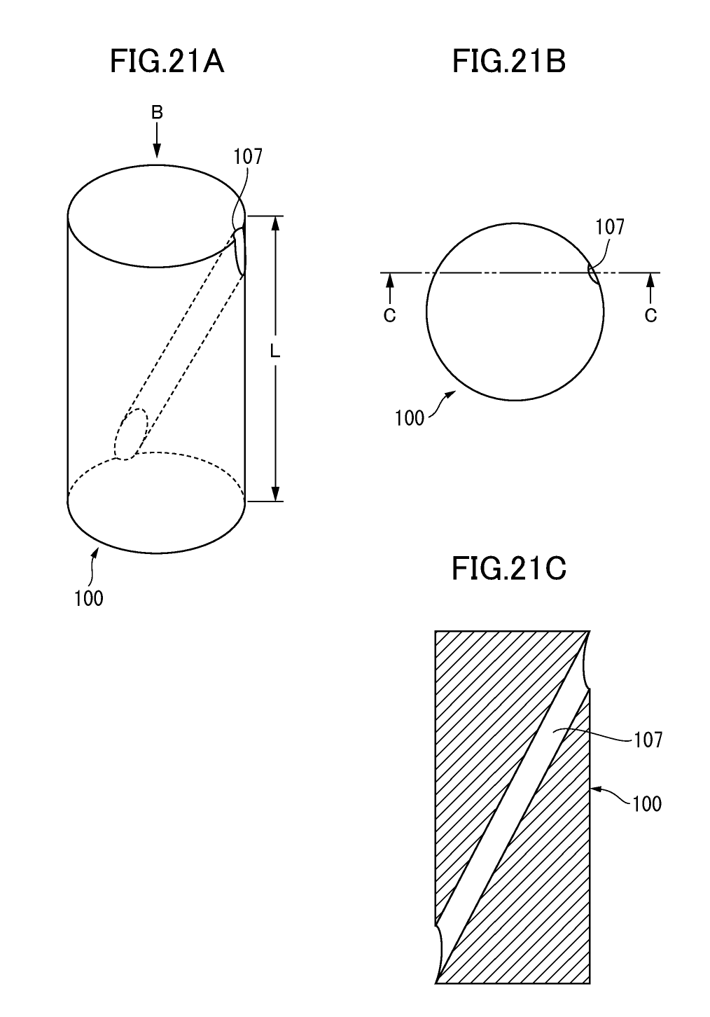

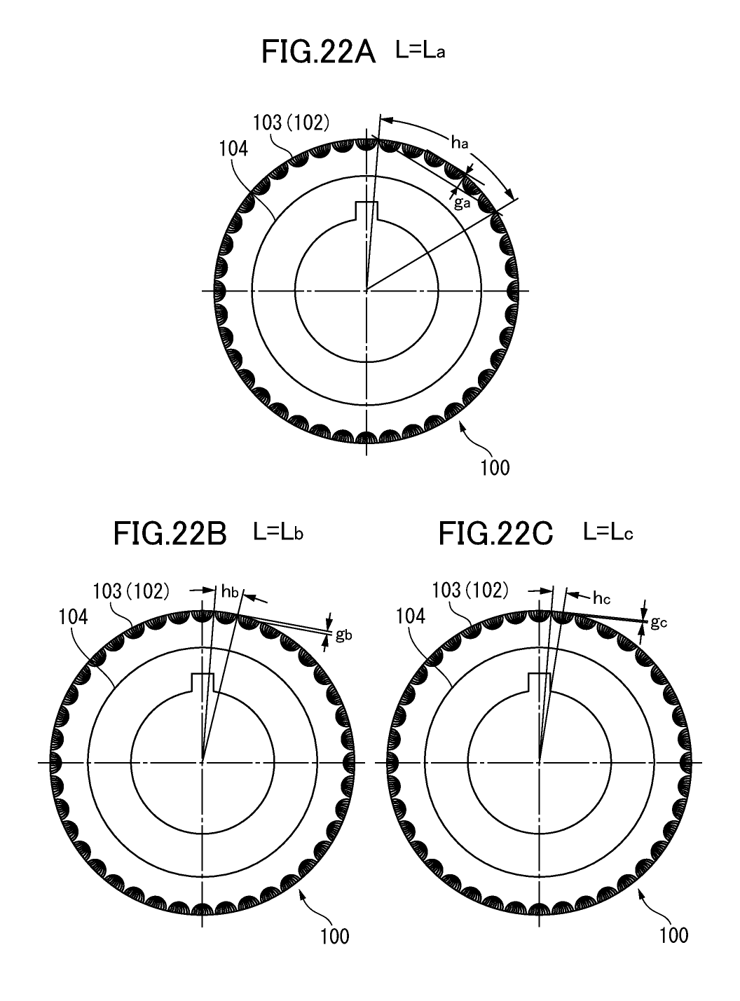

When carrying out the cutter portion forming step for the cutter block 100 by wire electrical discharge machining, as illustrated in FIG. 21A to FIG. 21C, investigation was conducted into a relationship between the axial length L of the cutter block 100 and the lead 107 formed of the array of the cutting blades 103 (see FIG. 22A to FIG. 220) arranged with inclination with respect to the direction of the rotary shaft.

In this example, as illustrated in FIG. 22A to FIG. 22C, the axial length L of the intermediate component, in which the outer diameter of each cutter portion 102 of the cutter block 100 was set to 42.5 mm, the height of each cutting blade 103 was set to 5 mm, and the inclination angle θ of the lead 107 formed of the array of the cutting blades 103 with respect to the rotary shaft was set to 4.2°, was set differently as La (in this example, 335 mm), Lb (in this example, 50 mm), and Lc (in this example, 25 mm). As the performance of the lead 107 formed at that time, angles h (specifically, ha, hb, and hc) of displacement of cutting edges on a near side and a far side due to the lead 107 of the cutter block 100 and maximum recess amounts g (specifically, ga, gb, and gc) of the lead 107 at the axial center of the cutter block 100 were measured.

The results are shown below.

| L | La | Lb | Lc |
|---|---|---|---|
| h (°) | 66.3 | 9.9 | 5.0 |
| g (mm) | 3.46 | 0.08 | 0.02 |

According to the above-mentioned results, it is understood that, when the axial length L of the cutter block 100 is large as in the case of La, the maximum recess amount g (ga) of the lead 107 of the cutter block 100 is increased, and hence the outer diameter dimension of the cutter assembly 311 (321) constructed of the plurality of cutter blocks 100 fluctuates so that the shredding performance may be degraded correspondingly.

In this respect, for example, when the axial length L of the cutter block 100 is set smaller as in the case of Lb or Lc, the maximum recess amount g (gb or gc) of the lead 107 of the cutter block 100 is reduced, thereby substantially eliminating the risk of fluctuation in outer diameter dimension of the cutter assembly 311 (321). Thus, it is understood that, when the axial length L of 50 mm or less is selected for the cutter block 100 according to this example, the accuracy of the outer diameter of the cutter assembly 311 (321) is not adversely affected even if the lead 107 is formed of the array of the cutting blades 103 of the cutter portions 102 by wire electrical discharge machining.

1. A shredding mechanism configured to shred an object to be shredded, which is conveyed into the shredding mechanism,
the shredding mechanism comprising a pair of cutter modules arranged so as to mesh with each other,
each of the pair of cutter modules comprising:
a rotary shaft extending along a width direction intersecting with a conveyance direction of the object to be shredded;
a plurality of divided cutter blocks arranged along a direction of the rotary shaft and assembled and fixed onto the rotary shaft,
each of the plurality of divided cutter blocks comprising cutter portions each having a circular shape in cross-section with cutting blades formed on a periphery of each of the cutter portions at a predetermined pitch,
the cutter portions being arranged in a plurality of stages through intermediation of spacer portions each having a circular shape in cross-section and having a predetermined width,
the cutter portions and the spacer portions being arranged so that an array of the cutting blades is inclined at a predetermined angle with respect to the direction of the rotary shaft; and
a positioning mechanism configured to position an assembly of the plurality of divided cutter blocks and the rotary shaft so that the cutting blades of the cutter portions of the each of the plurality of divided cutter blocks are arranged in an array inclined continuously with the cutting blades of the cutter portions of an adjacent one of the plurality of divided cutter blocks.

2. A shredding mechanism according to claim 1, further comprising a cleaning mechanism configured to clean the pair of cutter modules so as to remove, from the pair of cutter modules, shreds generated through shredding in a meshing region between the pair of cutter modules.

3. A shredding mechanism according to claim 1, wherein, in the cutter portions of the each of the plurality of divided cutter blocks, which have the cutting blades arranged in an array inclined at the predetermined angle, a circumferential distance between one of the cutting blades positioned so as to face one side surface of the each of the plurality of divided cutter blocks in the direction of the rotary shaft and another one of the cutting blades positioned so as to face another side surface of the each of the plurality of divided cutter blocks in the direction of the rotary shaft is an integral multiple of the predetermined pitch of each of the cutting blades.

4. A shredding mechanism according to claim 1, wherein, in the each of the plurality of divided cutter blocks, a thickness of each of the spacer portions is selected so as to become larger than a thickness of the each of the cutter portions.

5. A shredding mechanism according to claim 1, wherein, in the each of the plurality of divided cutter blocks, at least the cutting blades of the cutter portions are formed by wire electrical discharge machining.

6. A shredding mechanism according to claim 1,
wherein the positioning mechanism is provided between the each of the plurality of divided cutter blocks and the rotary shaft or between adjacent cutter blocks among the plurality of divided cutter blocks, and
wherein the positioning mechanism comprises:
a key formed on one of the each of the plurality of divided cutter blocks and the rotary shaft or one of the adjacent cutter blocks among the plurality of divided cutter blocks so as to extend along the direction of the rotary shaft and project in a radial direction of the rotary shaft; and
a keyway formed in another one of the each of the plurality of divided cutter blocks and the rotary shaft or another one of the adjacent cutter blocks among the plurality of divided cutter blocks so that the key is slidably fitted to the keyway.

7. A shredder, comprising:
a shredder casing having a conveyance path for an object to be shredded;
the shredding mechanism of claim 1, which is mounted inside the shredder casing and configured to shred the object to be shredded, which is conveyed into the conveyance path; and
a trash receiver mounted inside the shredder casing and configured to receive shreds generated through shredding by the shredding mechanism.

8. A method of manufacturing a shredding mechanism configured to shred an object to be shredded, which is conveyed into the shredding mechanism,
the shredding mechanism comprising a pair of cutter modules arranged so as to mesh with each other,
each of the pair of cutter modules comprising:
a rotary shaft extending along a width direction intersecting with a conveyance direction of the object to be shredded;
a plurality of divided cutter blocks arranged along a direction of the rotary shaft and assembled and fixed onto the rotary shaft,
each of the plurality of divided cutter blocks comprising cutter portions each having a circular shape in cross-section with cutting blades formed on a periphery of each of the cutter portions at a predetermined pitch,
the cutter portions being arranged in a plurality of stages through intermediation of spacer portions each having a circular shape in cross-section and having a predetermined width,
the cutter portions and the spacer portions being arranged so that an array of the cutting blades is inclined at a predetermined angle with respect to the direction of the rotary shaft; and
a positioning mechanism configured to position an assembly of the plurality of divided cutter blocks and the rotary shaft so that the cutting blades of the cutter portions of the each of the plurality of divided cutter blocks become continuous with the cutting blades of the cutter portions of an adjacent one of the plurality of divided cutter blocks,
the method comprising carrying out wire electrical discharge machining for at least processing of the cutting blades of the cutter portions during a manufacturing step for the each of the plurality of divided cutter blocks.

9. A method of manufacturing a shredding mechanism according to claim 8, wherein the manufacturing step for the each of the plurality of divided cutter blocks comprises:
a spacer portion forming step for forming recessed portions corresponding to the spacer portions by cutting work in regions each positioned between the cutter portions on a peripheral surface of a cylindrical block body; and
a cutter portion forming step for processing the cutting blades by the wire electrical discharge machining in regions of the cutter portions each positioned between the recessed portions on the peripheral surface of the cylindrical block body having the recessed portions formed through the spacer portion forming step.

10. A method of manufacturing a shredding mechanism according to claim 9, further comprising a heat treatment step for quenching the cylindrical block body having the recessed portions formed through the spacer portion forming step, the heat treatment step being carried out in a stage between the spacer portion forming step and the cutter portion forming step.

11. A shredder, comprising:
a shredder casing having a conveyance path for an object to be shredded;
the shredding mechanism of claim 2, which is mounted inside the shredder casing and configured to shred the object to be shredded, which is conveyed into the conveyance path; and
a trash receiver mounted inside the shredder casing and configured to receive shreds generated through shredding by the shredding mechanism.
